(19) United States
(12) Patent Application Publication
(10) Pub. No.: US 2005/0141636 A1
(43) Pub. Date: Jun. 30, 2005

(54) Modulator and semiconductor integrated circuit including modulator and wired or wireless communication device including modulator and semiconductor device

(75) Inventors: Yoshihisa Minami, Otsu-shi (JP); Takuo Hino, Osaka-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 11/020,259

(22) Filed: Dec. 27, 2004

(30) Foreign Application Priority Data
Dec. 26, 2003 (JP) 2003-432183

(51) Int. Cl. H04L 27/04

(52) U.S. Cl. 375/295; 332/128

(57) ABSTRACT

The present invention directly modulates the VCO in accordance with transmission data, reduces the circuit scale and current consumed during transmission and obtains a highly accurate modulated output. A transmission data signal converted into an IQ modulation signal with a predetermined modulation bandwidth that is phase-modulated by the select control signal inputted to the ROM via the modulation circuit. The IQ modulation signal is converted into an analog signal by means of the DAC, and the analog signal is inputted to the gm adjustment device via the noise filter before being converted to an appropriate signal level that corresponds with the control sensitivity of the VCO. The converted analog signal is inputted to a second input terminal for controlling the direct frequency of the VCO and the oscillation frequency of the VCO is modulated. Switching of the BAND of the VCO is controlled by inputting a control signal that is outputted by the BAND CTRL to the third input terminal of the VCO and the control terminal of the gm adjustment device at the same time as controlling the transmission conductance of the gm adjustment device in order to establish the modulation depth of the input signal from the second input terminal of the VCO that corresponds with the VCO control sensitivity, which varies for each BAND, at a target modulation depth, whereby a highly accurate modulated output is obtained.

### BACKGROUND OF THE INVENTION

1. Field of the Invention

The present invention relates to a modulation system used in a communication device and, more particularly, when the modulation system is constituted by installing an oscillator circuit in an IC, provides a modulator and a semiconductor integrated circuit comprising the modulator that permit a reduction in circuit scale while conserving electric power and allow an increase in the functionality of communication devices, and a wired or wireless communication device comprising the modulator and semiconductor device.

2. Description of the Related Art

FIG. 31 shows an example of a modulator in an FSK (Frequency Shift Keying) transmission system of the type that employs a transmission mixer that is employed in a conventional communication device. This circuit is a Bluetooth transmission system and illustrates an example of a frequency modulation system.

This system is an FSK transmission system that has an oscillator circuit that is completely built into an IC by employing a Voltage Controlled Oscillator (VCO) of the frequency band switching type, performs Quadrature modulation by employing two transmission mixers, and affords an image rejection function.

In FIG. 31, 101 is a reference signal device, 102 is a phase comparator, 103 is a loop filter, 104 is a divider, 105 is a VCO, 107 and 121 are filters, 108 and 120 are DAC, 109 is a ROM, 110 is a modulation circuit, 112 is a power amplifier (referred to as ‘PA’ hereinafter), 122 and 123 are transmission mixers (TxMIX), and 124 is a 90-degree phase shifter.

In the modulator shown in FIG. 31, the oscillation frequency of the VCO 105 is PLL-controlled, and the PLL (Phase Locked Loop) circuit is constituted by the VCO 105, the phase comparator 102, the divider 104, and an oscillator reference signal device 101 that uses a crystal or the like. The modulator is constituted to operate by comparing the signal of the reference signal device 101 with a signal rendered by dividing the signal of the VCO 105 by means of the phase comparator 102 and then smoothing the output of the phase comparator 102 by means of the loop filter 103 before supplying the output of the loop filter 103 to the VCO 105. As a result of this constitution, the oscillation frequency of the VCO 105 is controlled to a fixed frequency and, when the oscillation frequency of the VCO 105 is changed, this control is implemented by changing the division ratio of the divider 104.

The VCO 105 has a band switching function that affords a plurality of frequency bands by switching the capacitance value of a resonant capacitor by means of a switch to cover the required oscillation frequency bandwidth. This is because, when the VCO 105 is built into an IC, the oscillation frequency range of the VCO 105 must be broad in view of inconsistencies between each of the elements.

The operation of a transmission system that employs this VCO 105 will now be described. Transmission data is inputted to the modulation circuit 110 and digitally processed by the modulation circuit 110. An IQ signal corresponding with the transmission data is stored in the ROM 109 and data corresponding with the output of the modulation circuit 110 is outputted to the DAC 108, 120 by the ROM 109. The digital signal is converted into an analog signal by the DAC 108, 120. The signal is an analog signal following the DAC 108, 120 and an IQ2-channel output signal is outputted from each of the DAC 108, 120. The filters 107, 121 for lowering the sampling frequency of the DAC are each connected to the outputs of the DAC 108, 120 respectively and the sampling frequency component of the DAC 108, 120 is removed.

Signals following the filters 107, 121 and the signal after the output signal of the VCO 105 has passed through the 90-degree phase shifter 124 undergo Quadrature modulation by means of the transmission mixers 122, 123 to create a transmission signal. By performing IQ Quadrature modulation, the oscillation frequency component of the VCO 105 and the image frequency component can be removed from the output transmission signal.

In order to amplify the output of the transmission mixers 122, 123, this output is outputted via the PA112. A modulator of a Bluetooth transmission system was detailed above.

Further, there exist well-known documents such as JP 2001-148721A that relate to conventional FPS modulators.

However, a conventional Quadrature modulation-type FSK transmission system that uses a transmission mixer of this kind requires an extremely large number of circuits such as a transmission mixer and a 90-degree phase shifter in order to obtain a transmission signal. In a conventional FSK transmission system, the current consumed by the circuit increases and it is extremely difficult to retain accurately the 90-degree phase difference between the two signals due to inconsistencies, temperature fluctuations, and so forth.

### SUMMARY OF THE INVENTION

The present invention is directed towards solving the problems of the conventional technology and it is an object thereof to provide a modulator and semiconductor integrated circuit that comprises this modulator, as well as a wired or wireless communication device that comprises the modulator and a semiconductor device that make it possible to reduce the circuit scale and the current consumed during transmission without using a transmission mixer or 90-degree phase shifter by directly modulating the VCO in accordance with transmission data.

In order to achieve this object, a first modulator according to the present invention comprises a reference signal device that outputs a reference signal; a phase comparator; a loop filter; a divider; a voltage controlled oscillator (VCO) that comprises a first input terminal for controlling an oscillation frequency, a second input terminal for controlling the frequency directly independently of the first input terminal and a third input terminal for controlling the oscillation frequency bandwidth; a conductance adjustment device (gm adjustment device); a noise filter; a digital/analog converter (DAC); a read-only memory (ROM); a modulation circuit that generates a select control signal on the basis of an inputted transmission data signal; a band controller that controls the oscillation frequency bandwidth; and a power amplifier that amplifies and outputs an input via a buffer of the output modulation signal from the VCO, in which the reference signal and the output signal of the VCO that has passed via the divider are inputted to the phase comparator, and a phase-locked loop (PLL) is constituted by the phase comparator, the loop filter, the VCO, and the divider, wherein the oscillation frequency of the VCO is modulated by converting a transmission data signal into an IQ modulation signal with a predetermined modulation bandwidth that is phase-modulated by the select control signal inputted to the ROM via the modulation circuit, converting the IQ modulation signal into an analog signal by means of the DAC, and inputting the analog signal to the gm adjustment device via the noise filter before converting the analog signal to an appropriate signal level that corresponds with the control sensitivity of the VCO and inputting the converted analog signal to a second input terminal for controlling the direct frequency of the VCO; and switching of the oscillation bandwidth (BAND) of the VCO is controlled by inputting a control signal that is outputted by the band controller to the third input terminal of the VCO and the control terminal of the gm adjustment device at the same time as controlling the transmission conductance of the gm adjustment device in order to establish the modulation depth of the input signal from the second input terminal of the VCO that corresponds with the VCO control sensitivity, which varies for each BAND, at a target modulation depth.

As a result of this constitution, the oscillation center frequency of the VCO is controlled; the transmission data signal is adjusted to an appropriate amplitude by the gm adjustment device and then inputted to the VCO; VCO direct modulation is implemented by making the time constant of the PLL loop filter sufficiently large so that the PLL does not track the frequency fluctuations during VCO modulation; highly accurate modulation is permitted by adjusting the conductance of the gm adjustment device for each oscillation BAND by means of band controller and a modulator not requiring two channels to subject a modulation signal to Quadrature modulation can be constituted without employing a Quadrature signal of a transmission mixer or 90-degree phase shifter, whereby the stability of the modulator can be improved and an appropriate modulation depth can be retained.

Further, a second modulator is constituted such that, in the first modulator, the gm adjustment device comprises a first input terminal to which a BAND switching control signal is inputted by the band controller and a second input terminal to which the output of the loop filter is inputted; the output of the loop filter is inputted to the second input terminal; and, after the BAND is set, the transmission conductance of the gm adjustment device is controlled in accordance with the frequency controlled by the PLL, whereby a stable and appropriate modulation depth can be maintained also for the all-usage frequency in the selection band along with the fixing control by the band controller.

In addition, a third modulator is constituted such that, in the first modulator, a DAC control circuit (DAC CTRL) that outputs an offset adjustment signal for the DA-converted output is provided; the DAC comprises a first input terminal for inputting an IQ modulation signal from the ROM and a second input terminal for inputting the DA-converted output offset adjustment signal to be outputted; the output of the DAC CTRL is connected to the second input terminal of the DAC; and a shift in the center frequency of the modulation frequency that is produced as the signal progresses from the output of the DAC to the VCO is corrected by means of the DAC CTRL, whereby a shift in the center frequency of the outputted modulation signal can be eliminated.

Further, a fourth modulator is constituted such that, in the first modulator, the output stage of the buffer comprises a counter that detects any of an upper limit, lower limit or modulation bandwidth of the modulation frequency; and a data comparison circuit that compares an upper limit frequency rated value, lower limit frequency rated value, or a rated value for the modulation frequency bandwidth of the modulation signal with information on a detected upper limit frequency, a detected lower limit frequency or a detected modulation frequency bandwidth of the input from the counter; and wherein the output of the buffer is inputted to the counter, the output of the counter is inputted to the data comparison circuit, respective items of information on the frequency of the modulation signal are compared and analyzed by the data comparison circuit, the favorability of the modulation is judged, the judgment result is inputted to the gm adjustment device as a control signal, and the modulation depth at which the upper limit frequency, lower limit frequency or modulation frequency bandwidth of the modulation signal has the correct value is controlled, whereby the stability of the modulation depth can be retained.

Further, a fifth modulator is constituted such that, in the fourth modulator, the output of the data comparison circuit is inputted to the band controller and, even when it is impossible to control the modulation depth at which the upper limit frequency, lower limit frequency or modulation bandwidth of the modulation signal has the correct value by means of the gm adjustment device alone, the modulation depth and BAND are controlled simultaneously by controlling the frequency BAND of the VCO by means of the band controller, whereby the modulation depth of the output modulation signal resulting from the fluctuations of the circuit characteristic can be retained.

Further, a sixth modulator is constituted such that, in the first modulator, the gm adjustment device comprises a first input terminal to which a signal from the noise filter is inputted, a second input terminal to which a signal from the band controller is inputted, and a third input terminal that allows the transmission conductance to be varied separately from the first and second input terminals; a temperature detector that detects the temperature of the environment and outputs a temperature variation as a signal is provided; the output of the temperature detector is connected to the third input terminal; and the output of the temperature detector for temperature fluctuations that arise in the modulation depth of the modulation signal as a result of temperature fluctuations of the oscillation frequency of the VCO, temperature fluctuations of the transmission conductance, and temperature fluctuations of the amplitude of the signal inputted to the gm adjustment device is inputted to the gm adjustment device and the transmission conductance is varied to counteract the temperature fluctuations of the modulation depth, whereby the modulation depth can be stabilized.

Further, a seventh modulator is constituted such that, in the first modulator, a frequency sensing circuit to which two signals, which are the output of the divider and the output from the reference signal device are inputted and which compares the frequencies of the two input signals and outputs the result; and a second loop filter to which the output of the frequency sensing circuit is inputted, are provided; a shift between a center frequency that is judged from the upper and lower limits of the oscillation frequency of the VCO and the frequency of a signal from the reference signal device is detected; and the output of the frequency sensing circuit is inputted to the gm adjustment device via the second loop filter and added together with a fixed offset to the output signal of the gm adjustment device, whereby fluctuations of the PLL lockup frequency that arise due to fluctuations of the average value of the frequency of the output modulation signal while the VCO is performing a modulation operation can be stabilized.

Further, eighth and ninth modulators are constituted such that, in the seventh modulator, the output of the second loop filter is combined with the output of the loop filter and inputted as a VCO control signal and the output of the frequency sensing circuit is combined with the output of the phase comparator and inputted as a VCO control signal via a loop filter, and, therefore, fluctuations of the frequency average of the comparable modulation wave are small, the time constant of the loop filter constituting the PLL can be reduced for stability of the VCO and stable control is also feasible by means of the time constant of the frequency sensing circuit, whereby the circuit scale of the system can be reduced.

In addition, a tenth modulator is constituted such that, in the first modulator, a second loop filter and a voltage comparator are provided; the phase comparator is newly provided with a second output terminal; the output of the second output terminal is inputted to the second loop filter; the output of the loop filter and the output of the second loop filter are each inputted to the voltage comparator; and the output of the voltage comparator is inputted to the gm adjustment device. As a result of this constitution, the output voltage of the loop filter and the output voltage of the second loop filter are compared by means of a voltage comparator and, in cases where the result of the comparison between the substantially held output voltage of the loop filter and the usually varying output voltage of the phase comparator varies greatly in a short time or exhibits a large variation rate, the comparison result is added as an offset to the output of the gm adjustment device, whereby large fluctuations of the oscillation frequency of the VCO caused by source voltage fluctuations and noise (interference), and so forth, can be prevented and the center frequency of the modulation signal can be stabilized.

Further, an eleventh modulator is constituted such that, in the tenth modulator, the voltage comparator comprises a reference voltage source that outputs a reference voltage instead of the inputted loop filter output; the output of the second loop filter and the reference voltage are inputted to the voltage comparator; and the output of the voltage comparator is inputted to the gm adjustment device, whereby the output voltage of the second loop filter and the reference voltage are compared and, in cases where the output voltage of the second loop filter and the reference voltage vary greatly over a long period, the comparison result is added as an offset to the output of the gm adjustment device, and, therefore, fluctuations over a long period such as temperature fluctuations of the oscillation frequency of the VCO can be prevented and the judgment accuracy for judging abrupt changes can be raised.

Furthermore, a twelfth modulator is constituted such that, in the first modulator, a counter to which the output of the VCO and a control signal that sets the final oscillation frequency of the VCO are inputted is provided; and the upper and lower limits for judging the count amount of the counter are set in accordance with the control signal thus inputted to the counter. As a result of this constitution, in cases where the count amount is greater than the set upper limit or smaller than the lower limit, the BAND of the VCO is switch-controlled on the basis of the judgment result and the control is repeated until a suitable oscillation frequency is reached, and the PLL is automatically fixed at the frequency of the input reference signal from the reference signal device, whereby the BAND can be switched so that the VCO is able to automatically oscillate at the target frequency.

Further, a thirteenth modulator is constituted such that, in the first modulator, an asynchronous detector that observes the output voltage of the loop filter and judges a state in which PLL phase lock-up is impossible is provided; and the output of the loop filter is also inputted to the asynchronous detector and the output of the asynchronous detector is inputted as a control signal for the band controller. As a result of this constitution, at the selected oscillation frequency bandwidth of the VCO, a state where phase lock-up of the oscillation frequency by the PLL loop is not possible is detected by the asynchronous detector and, upon judging that control of the oscillation frequency of the VCO has reached the upper limit or lower limit, the BAND of the VCO can be automatically switch-controlled to a BAND with an oscillation frequency permitting PLL phase lock-up.

In addition, a fourteenth modulator is constituted such that, in the first modulator, the phase comparator comprises a function to stop the comparison output and afford the output a high impedance state, and the loop filter comprises a function to hold and output an immediate-output DC voltage regardless of the input signal, wherein a PLL control signal for controlling the operation and stoppage of the respective functions of the phase comparator and loop filter is inputted. According to this constitution, as a result of the PLL control signal, during periods in which the VCO is performing a modulation operation, the PLL is rendered an open loop, the PLL tracks fluctuations of the average value of the frequency modulated by the VCO and the center frequency of the output modulation signal is prevented from shifting from a target value, whereas, during modulation-free periods, the PLL is rendered a closed loop and the oscillation frequency of the VCO is reset at the target value by means of the PLL control signal, whereby the modulation accuracy can be raised.

Furthermore, a fifteenth modulator is constituted such that, in the fourteenth modulator, a modulation signal judgment circuit that outputs the PLL control signal that is inputted to the phase comparator and the loop filter is newly provided; and the output signal of the modulation circuit is inputted to the modulation signal judgment circuit, the output of the modulation signal judgment circuit is inputted to the phase comparator and the loop filter. As a result of this constitution, the modulation signal judgment circuit judges whether the output signal of the modulation circuit is a modulation-free signal or a modulated signal and automatically renders the PLL an open loop when the output signal is a modulation-free signal, whereby stabilization of the oscillation frequency is permitted.

Further, a sixteenth modulator is constituted such that, in the fifteenth modulator, a delay circuit is installed between the DAC and noise filter in order to prevent the output signal of the modulation circuit from being transmitted to the VCO prior to completion of switching of the PLL loop to an open loop in cases where it is judged by the modulation signal judgment circuit that the output signal of the modulation circuit has been switched from a modulation-free signal to a modulated signal and where the PLL loop is switched from a closed loop to an open loop. As a result of this constitution, the oscillation frequency of the VCO, which corresponds to that when the PLL is in the closed loop state, is prevented from fluctuating as a result of the modulation signal, whereby the oscillation frequency can be stabilized.

Further, the seventeenth modulator is constituted such that, in the sixteenth modulator, the delay circuit comprises a control terminal for controlling a delay amount that is constituted to allow the delay amount to be controlled; and a circuit delay detection circuit that detects an operation delay or a transmission delay of a circuit, wherein the circuit delay detection circuit produces a delay amount that is the same as that of the delay circuit, noise filter and gm adjustment device, detects fluctuations in the circuit delay, outputs the fluctuations as an output signal and inputs the output signal to the control terminal of the delay circuit. As a result of this constitution, even when the time until the signal inputted to the modulation circuit reaches the VCO changes as a result of the temperature fluctuations or element variations, or the like, the delay amount of the delay circuit can be controlled to counteract variations as a result of the circuit delay detection circuit and the delay amount of the delay circuit can be set as the minimum delay amount, whereby the modulation operation can be stabilized.

Further, an eighteenth modulator is constituted such that, in the sixteenth modulator, the output signal of the modulation signal judgment circuit is also inputted to a band controller and, in cases where the oscillation frequency bandwidth of the VCO or the transmission conductance of the gm adjustment device is varied under the control of the band controller, the BAND of the VCO is switched in sync with a modulation-data modulation-free period or the conductance of the gm adjustment device is varied by means of a control signal that is inputted by the modulation signal judgment circuit. As a result of this constitution, by performing switching of the BAND of the VCO during periods of modulation of the output modulation signal, and, depending on the case, not performing variations or abrupt variations of the transmission conductance of the gm adjustment device, frequency fluctuations of the output signal in a modulation period can be prevented.

Further, a nineteenth modulator is constituted such that, in the sixteenth modulator, an average value detection circuit to which the DAC output signal and a transmission data signal are inputted and which detects the frequency average of the transmission data signal is newly provided; and the output of the average value detection circuit is converted to a suitable control signal including average value information and then inputted to the loop filter together with the output signal of the phase comparator. As a result of this constitution, shifts in the center frequency of the outputted modulation signal from the target value when the PLL tracks fluctuations of the frequency average of the transmission data signal as a result of a phase lock-up operation are corrected by inputting the signal detected by the transmission-data-signal average value detection circuit to the loop filter in advance, whereby the center frequency fluctuations of the outputted modulation signal can be stabilized.

Further, a twentieth semiconductor integrated circuit is rendered by using the modulators of claims 1 to 19 in a combined application.

A twenty-first semiconductor integrated circuit is a semiconductor integrated circuit, wherein a modulator rendered by using a modulator according to any one of claims 1 to 19 in a single or combined application is partially used.

In addition, a twenty-second wired and wireless communication device is a wired and wireless communication device that is partly constituted by a modulator rendered by using a modulator according to any of claims 1 to 19 in a single or combined application.

Furthermore, a twenty-third wired and wireless communication device is a wired and wireless communication device, wherein the semiconductor integrated circuit according to claim 20 is installed.

A twenty-fourth semiconductor integrated circuit is a semiconductor integrated circuit, wherein a modulator rendered by using a modulator according to any of claims 1 to 19 in a single or combined application is implemented by means of digital signal processing technology and is partially used.

Further, a twenty-fifth wired and wireless communication device is a wired and wireless communication device that partially comprises a semiconductor integrated circuit, wherein a modulator rendered by using a modulator according to any of claims 1 to 19 in a single or combined application is implemented by means of digital signal processing technology and is partially used.

As detailed hereinabove, the present invention solves the problems faced by the prior art by means of VCO direct modulation technology and technology for stabilizing the modulation performance of the VCO direct modulation technology and is capable of implementing an extremely stable, high-performance modulation system with a built-in VCO and further comprising a frequency modulation function by means of a very small circuit scale and power consumption.

### BRIEF DESCRIPTION OF THE DRAWINGS

FIG. 1 is a schematic block diagram showing an overall constitution of a modulator according to a first embodiment of the present invention;

FIG. 2 shows an example of a circuit of a voltage controlled oscillator (VCO) that permits direct modulation that is used by a modulator according to the first embodiment;

FIG. 3 illustrates a relationship between control sensitivity and modulation sensitivity of the VCO according to the first embodiment;

FIG. 4 is a schematic block diagram showing an overall constitution of a modulator according to the second embodiment of the present invention;

FIG. 5 illustrates a relationship between control sensitivity and modulation sensitivity of the VCO of the second embodiment;

FIG. 6 illustrates the relationship between the control sensitivity and modulation sensitivity of the VCO of the second embodiment;

FIG. 7 is a schematic block diagram showing an overall constitution of a modulator according to a third embodiment of the present invention;

FIG. 8 is a schematic block diagram showing an overall constitution of a modulator according to a fourth embodiment of the present invention;

FIG. 9 illustrates a frequency control method;

FIG. 10 is a block diagram showing an overall constitution of a modulator according to a fifth embodiment of the present invention;

FIG. 11 illustrates a BAND switching method for retaining modulation bandwidth;

FIG. 12 is a schematic block diagram showing an overall constitution of a modulator according to a sixth embodiment of the present invention;

FIG. 13 is a block diagram showing an overall constitution of a modulator according to a seventh embodiment of the present invention;

FIG. 14 shows a concept of a relationship between a transmission data bit string and modulation frequency;

FIG. 15 is a block diagram showing an overall constitution of a modulator according to an eighth embodiment of the present invention;

FIG. 16 is a schematic block diagram showing an overall constitution of a modulator according to a ninth embodiment of the present invention;

FIG. 17 illustrates time constants in digital processing;

FIG. 18 is a schematic block diagram showing an overall constitution of a modulator according to a tenth embodiment of the present invention;

FIG. 19 illustrates differences in outputs of loop filters with different time constants;

FIG. 20 is a schematic block diagram showing an overall constitution of a modulator according to an eleventh embodiment of the present invention;

FIG. 21 is a schematic block diagram showing an overall constitution of a modulator according to a twelfth embodiment of the present invention;

FIG. 22 is a schematic block diagram showing an overall constitution of a modulator according to a thirteenth embodiment of the present invention;

FIG. 23 illustrates a range of PLL lockup and an automatic BAND switching method;

FIG. 24 is a schematic block diagram showing an overall constitution of a modulator according to a fourteenth embodiment of the present invention;

FIG. 25 is a schematic block diagram showing an overall constitution of a modulator according to a fifteenth embodiment of the present invention;

FIG. 26 illustrates a method of automatically opening and closing a PLL loop by observing bit strings of transmission data;

FIG. 27 is a schematic block diagram showing an overall constitution of a modulator according to a sixteenth embodiment of the present invention;

FIG. 28 is a schematic block diagram showing an overall constitution of a modulator according to a seventeenth embodiment of the present invention;

FIG. 29 is a schematic block diagram showing an overall constitution of a modulator according to an eighteenth embodiment of the present invention;

FIG. 30 is a schematic block diagram showing an overall constitution of a modulator according to a nineteenth embodiment of the present invention; and

FIG. 31 is a schematic block diagram showing an overall constitution of a conventional modulator.

### DESCRIPTION OF THE PREFERRED EMBODIMENTS

Embodiments of the present invention will be described in detail hereinbelow with reference to the drawings.

### First Embodiment

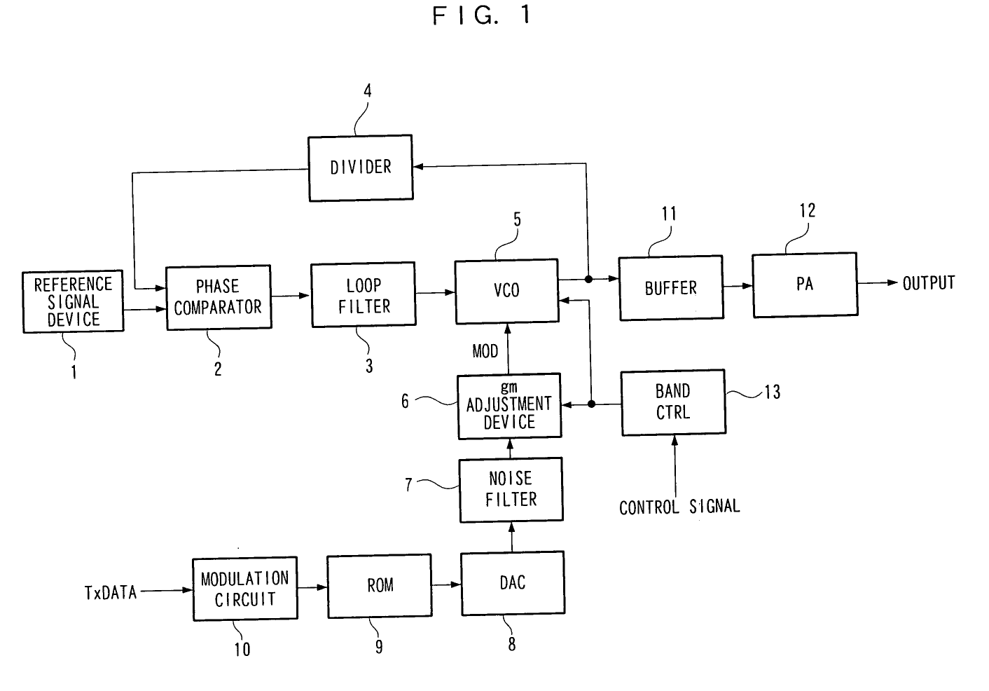

FIG. 1 is a block diagram showing the overall constitution of the modulator according to the first embodiment of the present invention. Further, constituent elements in each of the drawings below with substantially the same functions that correspond to the constituent elements described in FIG. 1 are shown with the same reference numerals assigned thereto.

In FIG. 1, 1 is a reference signal device, 2 is a phase comparator with two inputs that compares the phases of two inputted signals and outputs the phase difference as a signal, 3 is a loop filter that smoothes the output signal of the phase comparator, 4 is a divider, 5 is a VCO (Voltage Controlled Oscillator) that comprises a first input terminal to which a signal for controlling the emission frequency is inputted in order to constitute a PLL loop, a second input terminal to which a signal for controlling the frequency independently of the PLL loop is inputted, and a third input terminal to which a signal for switching the BAND in order to control the oscillation frequency bandwidth is inputted. 6 is a gm adjustment device that is able to vary the transmission conductance between the input and output by means of an input from the gm control terminal, 7 is a noise filter that eliminates noise, 8 is a DAC (D/A converter) which performs digital to analog conversion, 9 is a ROM for storing IQ modulation signal generation data, 10 is a modulation circuit that performs selective control on the basis of transmission data (TxDATA) and retrieves IQ modulation signal generation data from the ROM 9, 11 is a buffer for storing a modulation signal, 12 is a power amplifier (written as PA hereinafter), and 13 is BAND CTRL for controlling the oscillation bandwidth of the VCO 5.

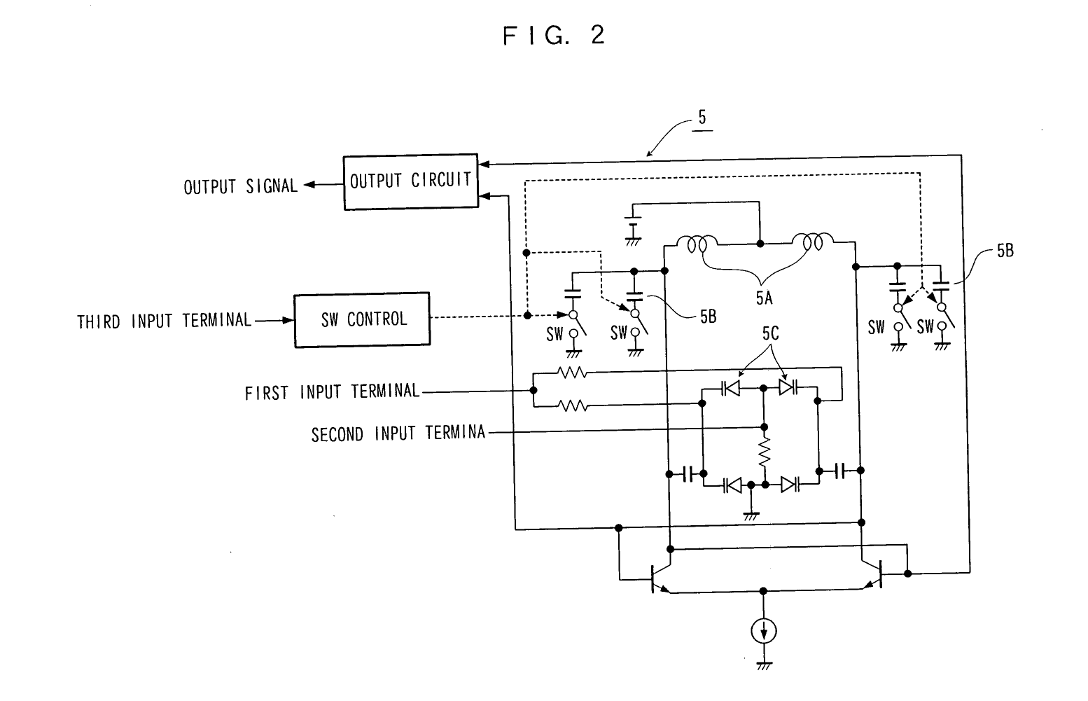

FIG. 2 shows a circuit example showing the constitution of the VCO. 5A are inductors that constitute an LC oscillation circuit, and 5B are static capacitors C. The static capacitors C of 5B are able to switch the BAND by controlling switches SW. 5C are variable capacitance diodes connected between the two terminals of the inductor L that control the oscillation frequency in accordance with voltage. The first input terminal is distributed and connected to the variable capacitance diodes 5C via resistors. The second input terminal is connected to a joining wire that is linked to a center portion of the variable capacitance diodes 5C.

As shown in FIG. 1, the reference signal of the reference signal device 1 and the output signal of the divider 4 are each inputted to the input of the phase comparator 2, while the output of the phase comparator 2 is inputted to the loop filter 3 and the output of the loop filter 3 is inputted to the first input terminal of the VCO 5. The output of the VCO 5 is inputted to the divider 4 and the buffer 11 and the output of the buffer 11 is inputted to the PA 12.

In addition, transmission data is inputted to the modulation circuit 10 and the output is inputted to the ROM 9. The output of the ROM 9 is then inputted to the DAC 8 and the output of the DAC 8 is inputted to the noise filter 7. The output of the noise filter 7 is inputted to the gm adjustment device 6, while the output of the gm adjustment device 6 is inputted to the second input terminal of the VCO 5.

Further, the modulator is constituted such that a control signal for the oscillation frequency bandwidth from the BAND CTRL 13 is inputted to the third input terminal for controlling the oscillation bandwidth of the VCO 5 and to the gm control terminal of the gm adjustment device 6 and the modulated output is obtained from the PA 12.

Further, a PLL is constituted by the phase comparator 2, the loop filter 3, the VCO 5, and the divider 4. The phases of the frequency of the reference signal from the reference signal device 1 and the oscillation frequency of the VCO 5 are compared and the result is fed back to the VCO 5, whereby the oscillation signal of the VCO 5 is phase-locked to the reference signal of the reference signal device 1. The time constant of the loop filter 3 is set so that the PLL tracks the fluctuations of the average value of the frequency of the output modulation signal resulting from direct modulation by the VCO 5 in accordance with transmission data and the oscillation frequency of the VCO 5 does not fluctuate.

The modulation circuit 10 outputs a select control signal for retrieving IQ modulation signal data stored in the ROM 9 on the basis of inputted transmission data and inputs the select control signal to the ROM 9, whereupon the ROM 9 outputs digital data of a plurality of bit lengths corresponding to the IQ modulation signal in accordance with the select control signal thus inputted thereto and then inputs the digital data to the DAC 8. The DAC 8 converts the digital signal inputted thereto to an analog signal and outputs same and the output of the DAC 8 is inputted to the gm adjustment device 6 via the noise filter 7.

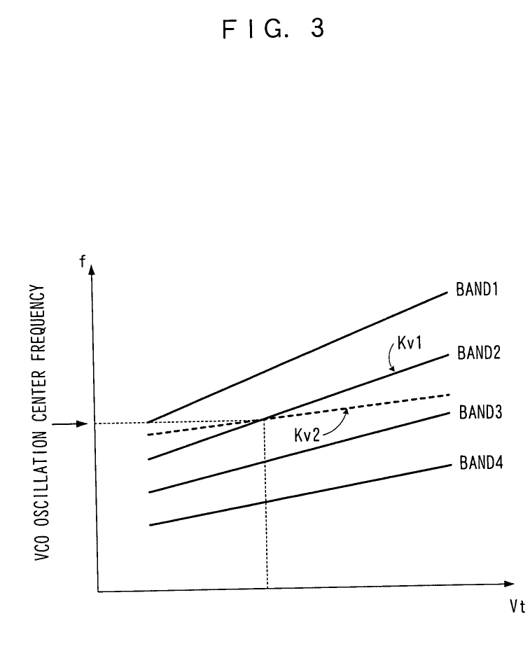

Here, in the VCO 5, although the optimum BAND for obtaining the transmission oscillation frequency is selected by means of the BAND CTRL 13, the control sensitivity Kv1 of the VCO 5 differs for each BAND (oscillation frequency bandwidth), as shown in FIG. 3. Further, Kv1 differs greatly from the modulation sensitivity Kv2 required in order to obtain an appropriate modulation bandwidth. As a result, in the gm adjustment device 6, the modulation signal amplitude is adjusted and outputted by adjusting the transmission conductance to establish the modulation sensitivity Kv2 for which the modulation bandwidth of the output of the VCO 5 is appropriate depending on the BAND of the VCO 5 by means of a control signal from the BAND CTRL 13.

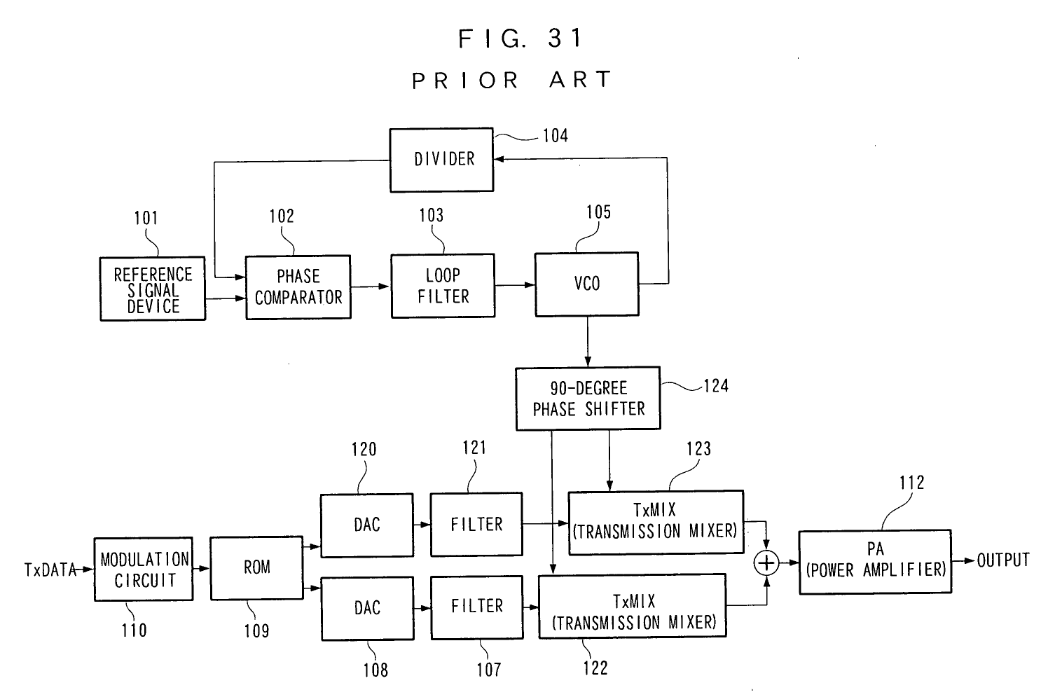

By inputting the output from the gm adjustment device to the second input of the VCO 5, the modulation system established through direct modulation of the VCO 5 is constituted and, by using the gm adjustment device 6, the transmission data signal inputted to the VCO 5 is adjusted for each band so that the modulation sensitivity (=VCO oscillation frequency control sensitivity) of the VCO 5 is then the modulation sensitivity that is actually required. As a result, the two signals of the 90-degree phase shifter 124 are not required as per the conventional example shown in FIG. 31, and, by using a direct modulation system that does not require the two transmission mixers 122 and 123 that consume a large amount of electrical power, a reduction in the circuit scale and consumption of electrical power, which are problems faced by the prior art, is feasible.

### Second Embodiment

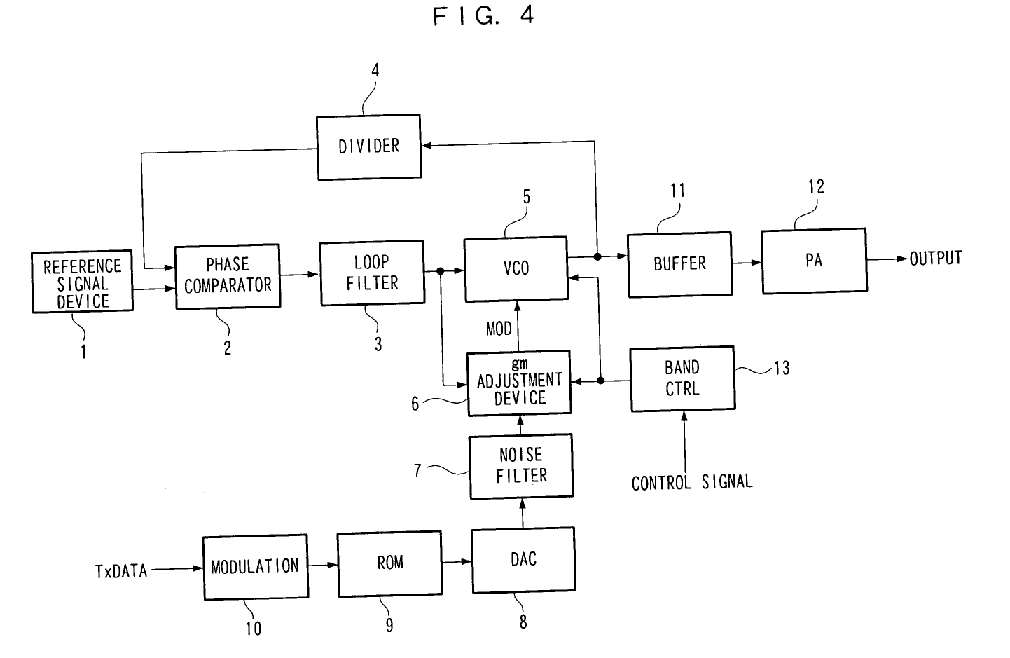

FIG. 4 is a block diagram showing the overall constitution of the modulator of the second embodiment of the present invention. As shown in FIG. 4, this modulator is constituted such that the output of the loop filter 3 in the block diagram shown in FIG. 1 is also inputted to the gm adjustment device 6.

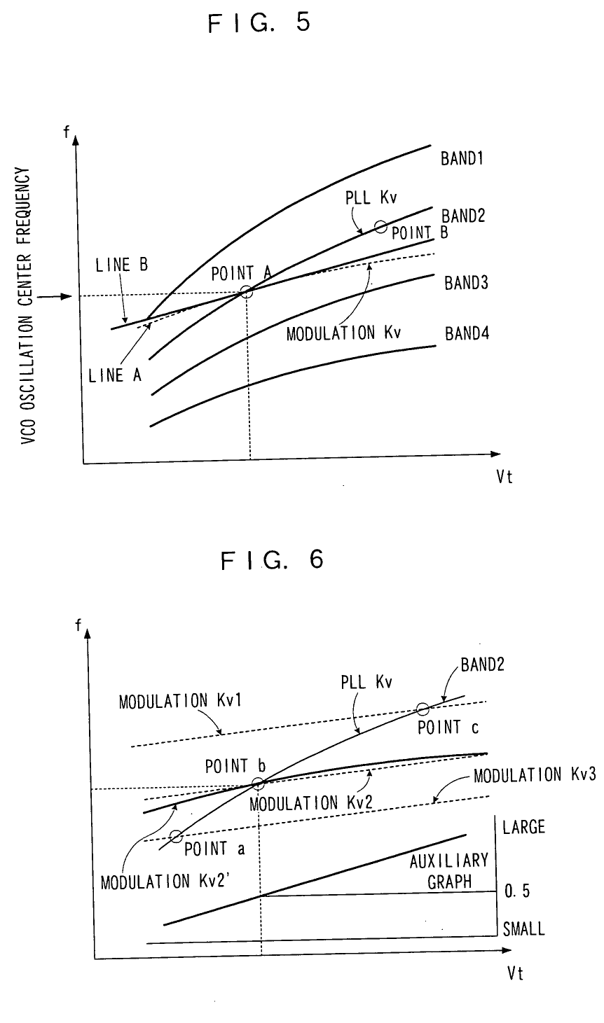

When a variable capacitance diode is used to control the oscillation frequency of the VCO 5, any change in the oscillation frequency with respect to the frequency control voltage inputted to the VCO 5 is generally nonlinear. For example, when two points, which are points A and B marked with a round circle on curve BAND2 are taken by way of example as shown in FIG. 5, it can be clearly seen that the inclination at these points is different because curve BAND2 is not a straight line.

Further, the same is true of the other BAND. In the second embodiment with regard to curve BAND2, where line B is the modulation sensitivity with the required inclination, the output of the loop filter 3, which is a voltage (written as ‘Vt’ hereinafter) for controlling the frequency of the VCO 5, is used, and Vt also corresponds to the control position of the oscillation frequency of the VCO 5. Therefore, in FIG. 6, for example, supposing that point b is the oscillation frequency control position targeted for the VCO 5, PLL Kv of BAND2 at point b is 1 MHz/V and the required modulation Kv is 0.5 MHz/V, the output signal amplitude of the gm adjustment device 6 is set as a multiple of 0.5 and the modulation Kv at point b is then 0.5 MHz/V.

Likewise, the other VCO 5 oscillation frequency control position may be varied by means of gain that is optimal at points a and c, for example, in proportion with Vt. When the relationship between Vt and control of conductance is made linear as per the auxiliary graph shown in FIG. 6 on this occasion, the PLL Kv is nonlinear. Therefore, the modulation Kv2′ is also nonlinear as per line A in FIG. 5. Therefore, a modulator that allows the control linearity of the modulation sensitivity to be enhanced and the modulation accuracy to be increased by varying the transmission conductance of the gm adjustment device 6 in proportion to Vt, is implemented. In the second embodiment, although a case where a Vt-based conductance variation is linear was taken by way of example, a nonlinear variation may be implemented.

### Third Embodiment

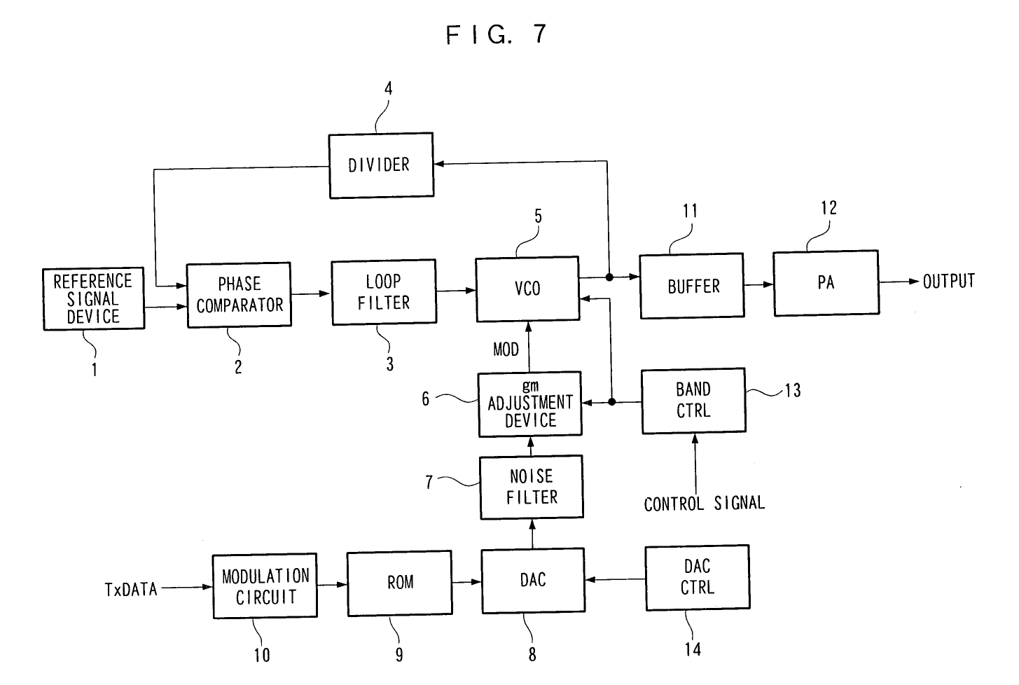

FIG. 7 is a block diagram showing the overall constitution of the modulator according to the third embodiment of the present invention. As shown in FIG. 7, this modulator is constituted such that the DAC 8 in the block diagram shown in FIG. 1 comprises a DC offset adjustment function for the output signal and a terminal for controlling this function, as well as a DAC CTRL 14 for adjusting the DC offset of the output signal of the DAC 8, wherein the control signal outputted by the DAC CTRL 14 is inputted to the offset control terminal with which the DAC 8 is provided.

When the DC level of the output signal of the gm adjustment device 6 varies as a result of fluctuations of the circuit characteristics in the process in which the output of the DAC 8 is inputted to the second input of the VCO 5 via the noise filter 7 and gm adjustment device 6, the center frequency of the output modulation signal of the VCO 5 also fluctuates. Further, because fluctuations of the oscillation frequency also arise in the VCO 5 itself due to temperature fluctuations and the like, these fluctuations can be corrected by adjusting the DC level of the output signal of the DAC 8 by means of the DAC CTRL 14 and correcting the fluctuations of the center frequency of the modulation signal to the correct value.

### Fourth Embodiment

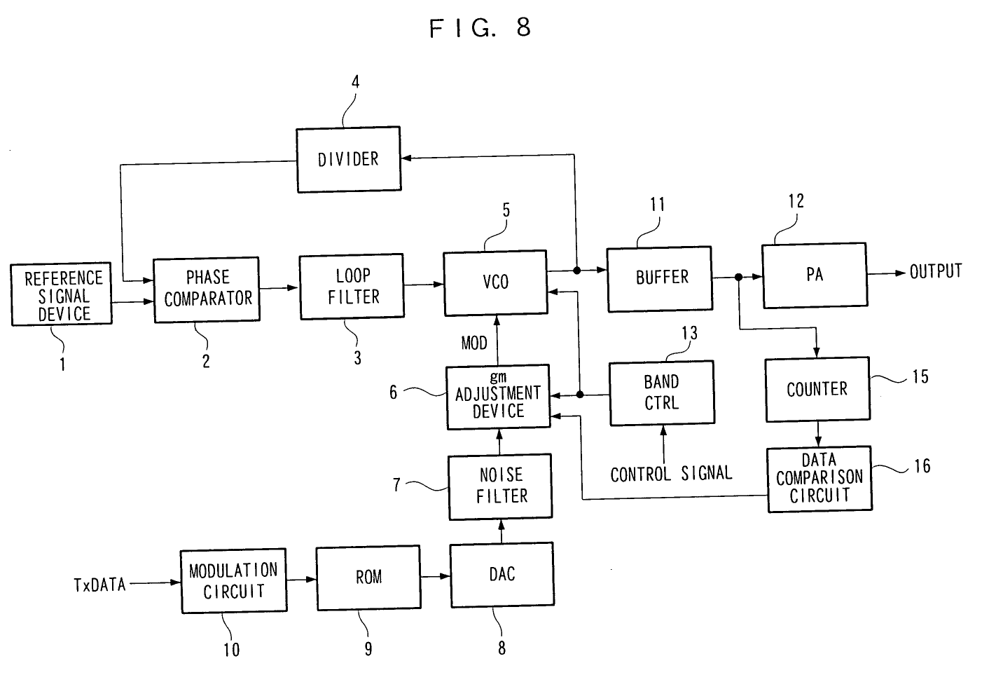

FIG. 8 is a block diagram showing the overall constitution of the modulator according to the fourth embodiment of the present invention. As shown in FIG. 8, this modulator is constituted by providing the block diagram shown in FIG. 1 with a counter 15, which newly detects any of the upper limit, lower limit, or modulation bandwidth of the modulation frequency, and a data comparison circuit 16, which compares the upper limit frequency rated value or the lower limit frequency rated value of the modulation signal, or the rated value for the modulation frequency bandwidth with the inputted information on the detected upper limit frequency, the detected lower limit frequency, or the detected modulation frequency bandwidth respectively, wherein the output of the buffer 11 is inputted to the counter 15 and the output of the counter 15 is inputted to the data comparison circuit 16.

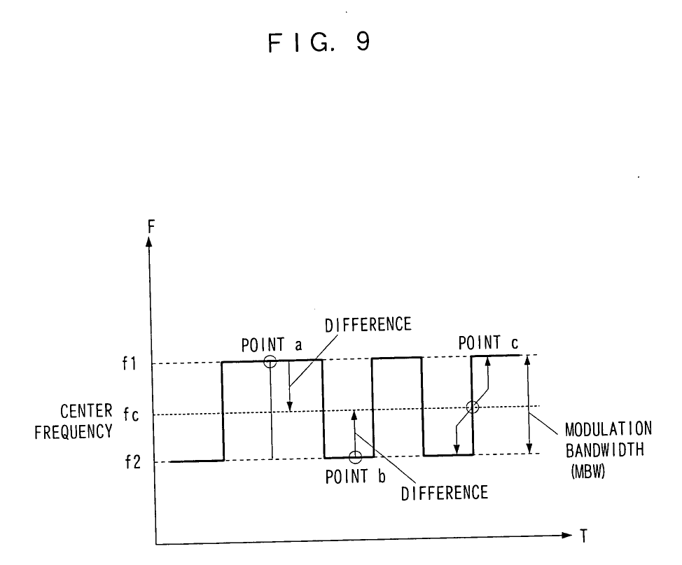

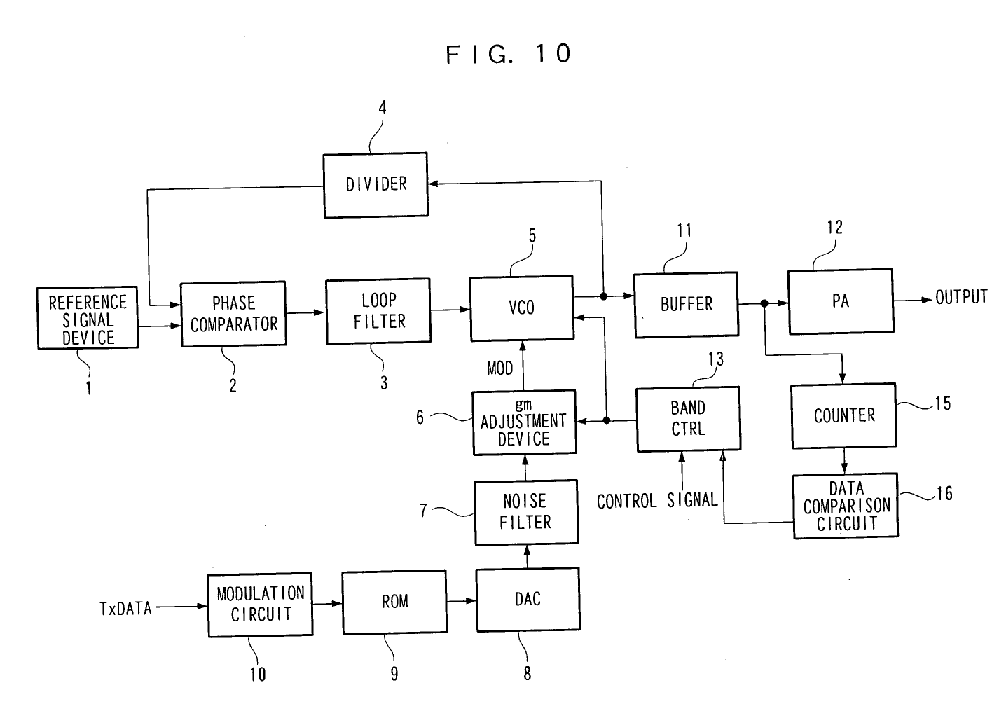

In the data comparison circuit 16, as shown in FIG. 9, for example, when the frequency is modulated to give f1 and f2 in correspondence with data bits “0” and “1” respectively, if, assuming that the respective frequencies are detected at points a and b and the center frequency (fc) is correctly adjusted, the difference between f1 or f2 and fc is a multiple of 2, the modulation bandwidth (MBW) is rendered. Otherwise, by performing an analysis by detecting the two frequencies f1 and f2 and finding MBW as per point c, it is judged whether modulation has been performed correctly and, by inputting the judgment result to the gm adjustment device 6 as a control signal, control of the modulation depth is repeated so that the upper limit frequency, lower limit frequency, or modulation bandwidth of the modulation signal has the correct value.

As a result, fluctuations of the DC level of the signal inputted to the VCO 5 and fluctuations of each modulation depth resulting from temperature fluctuations and so forth in the VCO 5 itself, which are problems to be solved that were mentioned in the third embodiment above, can be automatically corrected.

### Fifth Embodiment

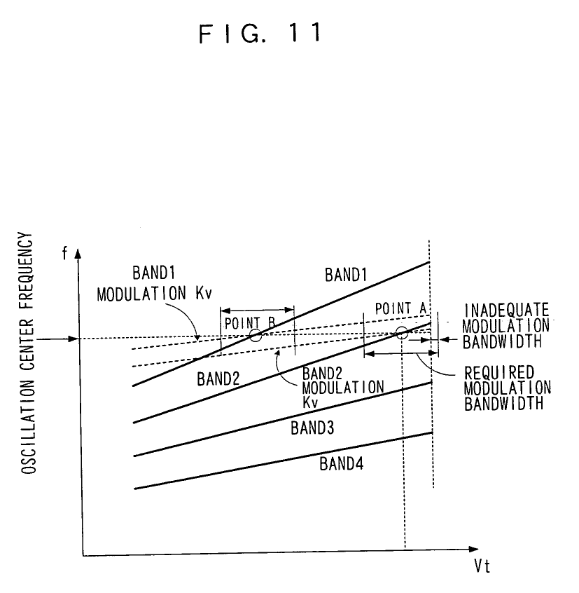

FIG. 10 is a block diagram showing the overall constitution of the modulator of the fifth embodiment of the present invention. As shown in FIG. 10, the modulator is constituted such that the output of the newly provided data comparison circuit 16 in the block diagram shown in FIG. 8 of the fourth embodiment is inputted to the BAND CTRL 13.

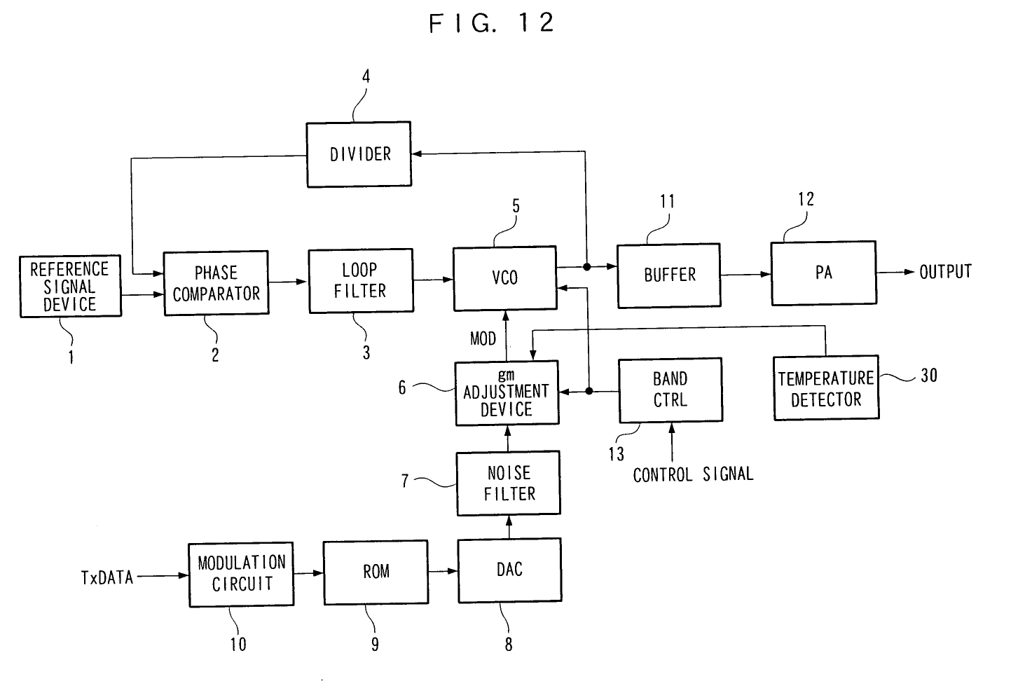

As a result of this constitution, when the modulation depth is adjusted so that the upper limit frequency, lower limit frequency or modulation bandwidth of the modulation signal has a correct value, in order to perform correction to the correct value by means of adjustment using only the gm adjustment device 6 within only the selected BAND of the VCO 5, it is impossible to correct the oscillation frequency at a terminal in an adjustable region of the BAND as shown at point A marked with a circle in FIG. 11 and hence modulation is inadequate. In this case also, the fact that adjustment is impossible is detected from the fact that the modulation bandwidth cannot be adjusted in the modulation bandwidth observation time or in a predetermined number of measurements and, hence, control is implemented to switch the modulator to the band that provides the oscillation frequency to which the frequency band of the VCO 5 is to be adjusted by means of the BAND CTRL 13. In the example in FIG. 11, the modulation depth can be controlled by controlling both the BAND and the modulation depth that allows control for performing an automatic switch from point A of BAND2 to point B of BAND1.

### Sixth Embodiment

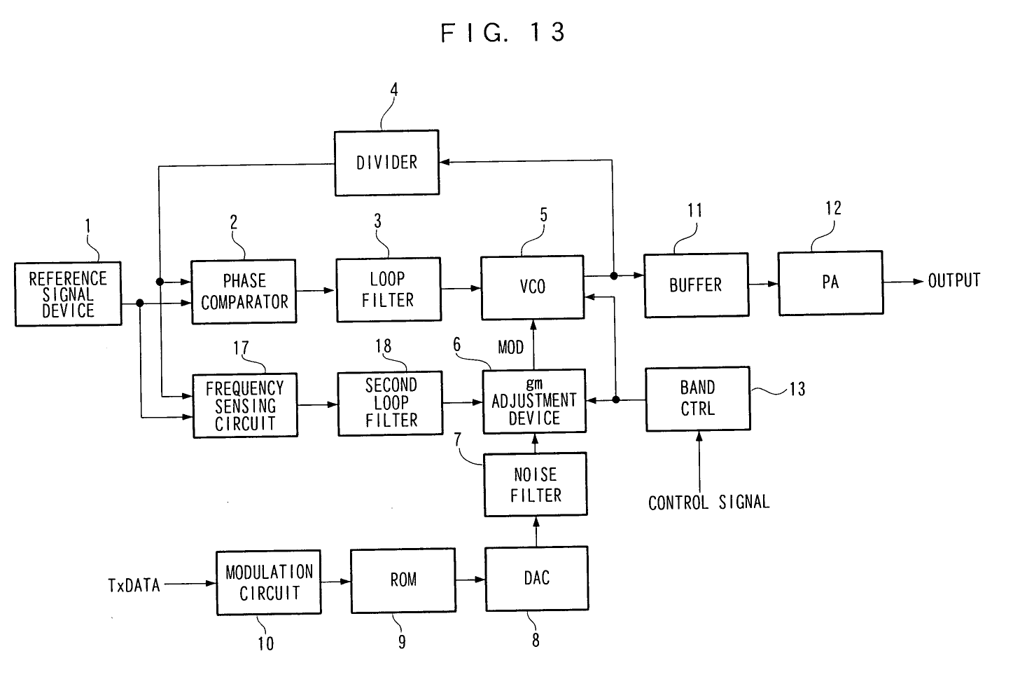

FIG. 12 is a block diagram showing the overall constitution of the modulator of the sixth embodiment of the present invention. As shown in FIG. 12, the modulator is constituted by providing the block diagram shown in FIG. 1 with a temperature detector 30, which detects the temperature of the environment of the device and outputs a temperature variation as a signal and by providing the gm adjustment device 6 with a third terminal for varying the transmission conductance independently of the modulation signal input from the noise filter 7 and gm control signal input from the BAND CTRL 13.

As a result of this constitution, the modulation depth can be stabilized by inputting the output of the temperature detector 30 to the gm adjustment device 6 to vary the transmission conductance in order to counteract modulation-depth temperature fluctuations with respect to frequency fluctuations caused by fluctuations of the modulation depth of the modulation signal as a result of oscillation frequency temperature fluctuations of the VCO 5, transmission conductance temperature variations of the gm adjustment device, and temperature fluctuations of the signal amplitude inputted to the gm adjustment device.

### Seventh Embodiment

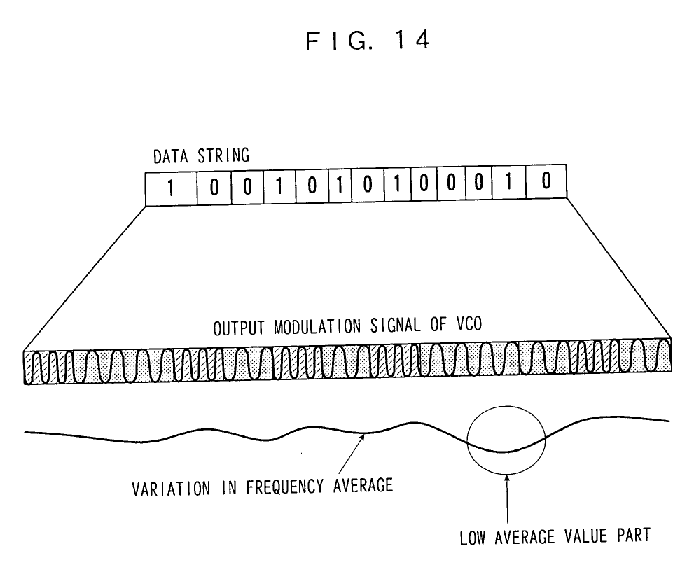

FIG. 13 is a block diagram showing the overall constitution of the modulator of the seven embodiment of the present invention. As shown in FIG. 13, the modulator is constituted by newly providing the block diagram shown in FIG. 1 with a frequency sensing circuit 17 and a second loop filter 18, to which two signals, namely the output of the divider 4 and the output of the reference signal device 1, are inputted, which compare the frequencies of the two inputted signals and output the comparison result.

As a result of this constitution, a shift between the center frequency, which is judged from the upper limit and lower limit of the oscillation frequency of the VCO 5, and the frequency of the reference signal from the reference signal device 1 are detected, the output of the frequency sensing circuit 17 is inputted to the gm adjustment device 6 via the second loop filter 18, and a fixed offset is added to the output signal of the gm adjustment device, whereby it is possible to stabilize fluctuations of the PLL lock-up frequency, which render the PLL incapable of phase-locking the transmission data accurately and arise as a result of fluctuations of the frequency average of the output modulation signal when the VCO 5 is performing a modulation operation.

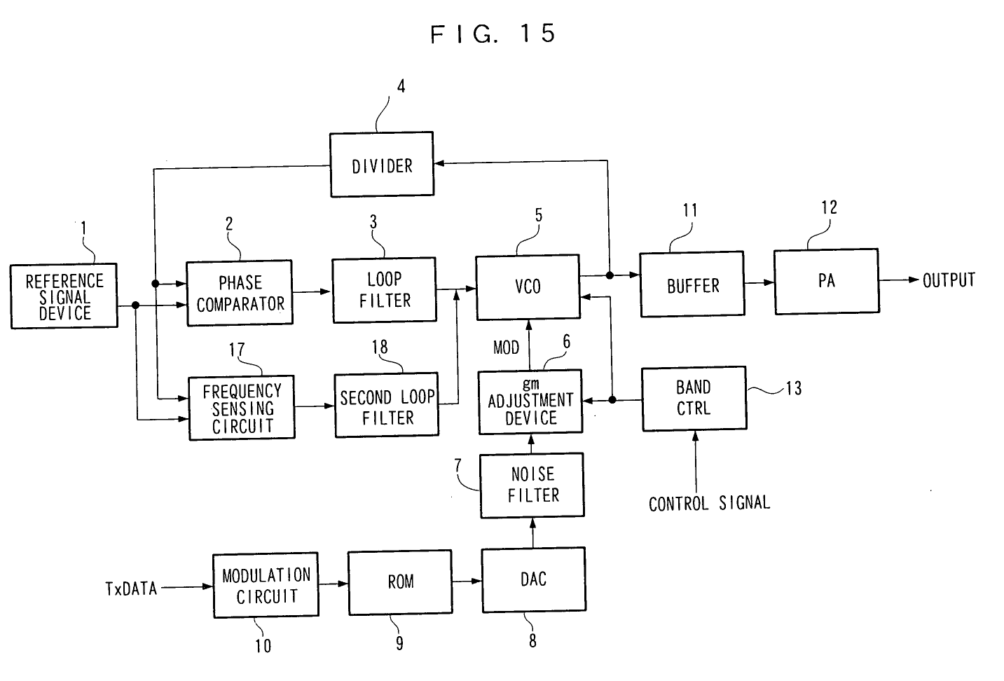

That is, as shown in FIG. 14, the list of ones and zeros of the bit string of transmission data (see TxDATA) is nonuniform and, therefore, the frequency average of the output modulation signal of the VCO 5 corresponding with the transmission data also fluctuates and, in cases where the average shifts greatly as in the case of the low-average segment shown in FIG. 14, the oscillation frequency of the VCO 5 tracked by the PLL shifts from the original frequency. Therefore, in this embodiment, the maximum and minimum values of the frequency are detected instead of the average of the output modulation signal by means of a frequency sensing circuit 17 and the frequency of the output modulation signal is stabilized by observing fluctuations of the center frequency value and adjusting the DC level of the output of the gm adjustment device 6 to correct the fluctuations of this center frequency value.

### Eighth Embodiment

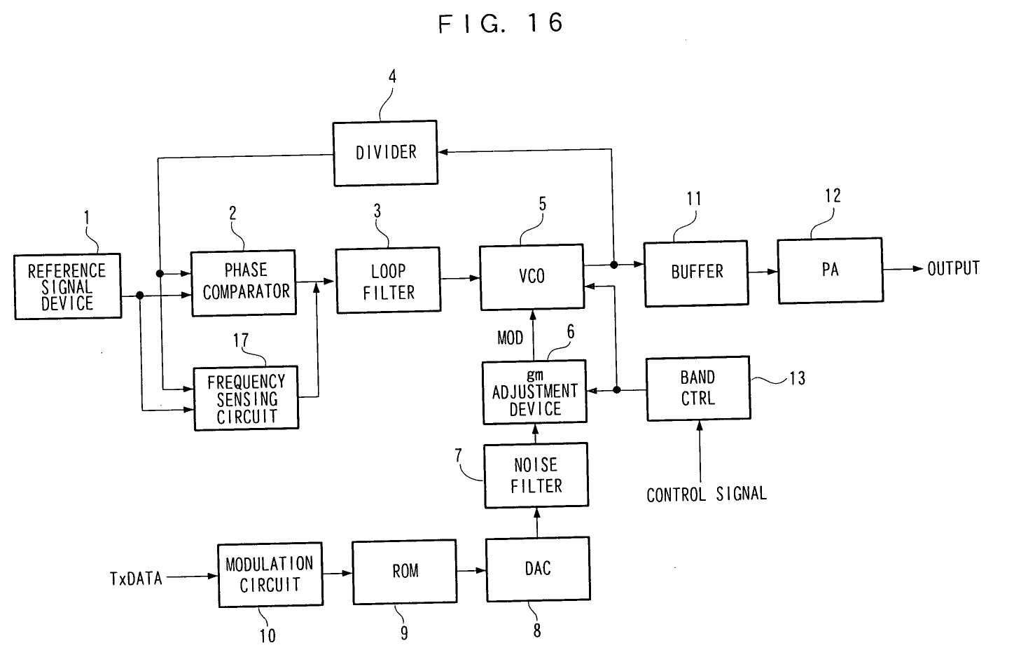

FIG. 15 is a block diagram showing the overall constitution of the modulator of the eighth embodiment of the present invention. As shown in FIG. 15, the modulator is constituted such that the output of the second loop filter 18 in the block diagram shown in FIG. 13 of the seventh embodiment is fed back to the output of the loop filter 3 and to the first input terminal of the VCO 5 rather than to the gm adjustment device. The gm adjustment device 6 performs control of the variation in conductance and so forth and therefore has a complex circuit and, because feedback through direct modulation of the second input terminal of the VCO 5 is implemented and the combining of lock-up function characteristics such as the control response of the VCO 5 is complex, the design can be simplified by implementing feedback to the first input terminal of the VCO 5.

### Ninth Embodiment

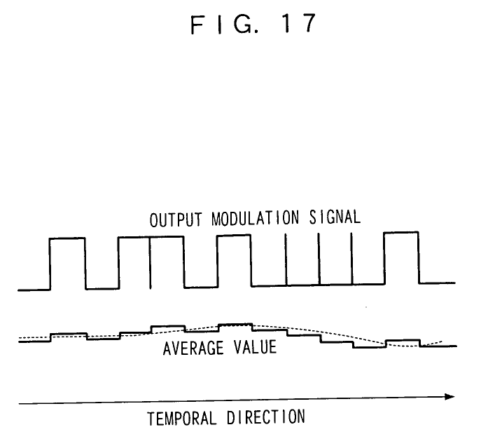

FIG. 16 is a block diagram showing the overall constitution of the modulator of the ninth embodiment of the present invention. As shown in FIG. 16, this modulator is constituted by removing the second loop filter 18 in the block diagram shown in FIG. 15 of the eighth embodiment and inputting the output of the frequency sensing circuit 17 to the loop filter 3 together with the output of the phase comparator 2. Although fluctuations of the frequency average of the modulation signal increase and the frequency sensing circuit 17 is generally easily implemented by a logic circuit, for example, supposing that same is constituted by a logic circuit, the frequency of the input signal is always counted, and a function to find the average is provided within the logic circuit, the effect of various factors such as the average processing data number, the signal sampling number, and the sampling interval come to bear.

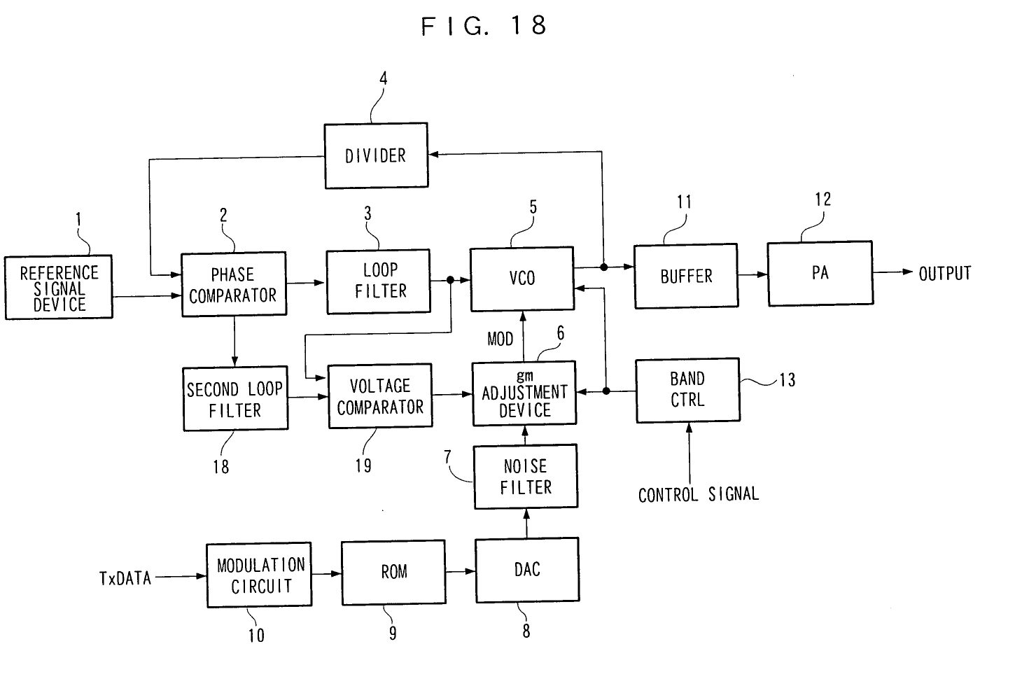

With regard to the output of the averaging process by a general logic circuit, as shown in FIG. 17, looking at the time axis, the logic averaging process output represents a characteristic that is similar to its time constant equivalent and, when this time constant produces a PLL characteristic that is the same as the characteristic in a case where the second loop filter 18 is employed, the second loop filter 18 can be removed and it is possible to prevent the complexity in the design of the PLL loop response characteristic that results from using the two loop filters, namely the loop filter 3 and second loop filter 18 as per the eighth embodiment.

### Tenth Embodiment

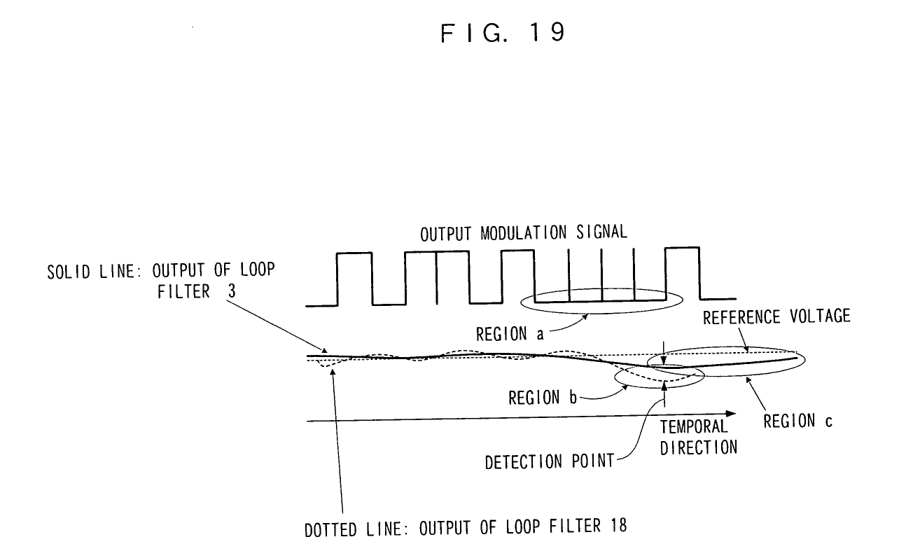

FIG. 18 is a block diagram showing the overall constitution of the modulator of the tenth embodiment of the present invention. As shown in FIG. 18, this modulator is constituted by newly providing the block diagram shown in FIG. 1 with the second loop filter 18 and a voltage comparator 19 and by also inputting the output of the phase comparator 2 to the second loop filter 18 and inputting two signals, namely the output signal of the loop filter 3 and the output signal of the second loop filter 18 to the voltage comparator 19.

In the first embodiment, the time constant of the loop filter 3 is made sufficiently large so that the PLL is not easily affected by fluctuations of the frequency average of the output modulation signal during modulation. The time constant of the second loop filter 18 is made relatively small in comparison with the time constant of the loop filter 3 and, when the oscillation frequency of the VCO 5 differs from the frequency of the reference signal inputted by the reference signal device 1, the two loop filters output an error signal that corresponds with this difference. Otherwise, the error signal increases as the difference between the two inputted signals increases. However, when the error signal is outputted as is, a PLL loop with a low time constant is constituted and the PLL lockup readily tracks the VCO modulation operation, which hinders the modulation operation. Therefore, the modulator may be constituted such that the output of the voltage comparator 19 is outputted upon exceeding the voltage range for controlling an output that is established beforehand.

The outputs of the loop filter 3 and second loop filter 18 that are produced when an error signal is inputted substantially at the same time by the phase comparator 2 are such that, because the time constant of loop filter 3 is set larger than the time constant of the second loop filter 18, the output of the second loop filter 18 is outputted before the smoothing signal of the inputted error signal as shown by the temporal positions from region a to region b in FIG. 19, and the output amplitude largely reflects this effect, whereby a large amplitude is outputted.

The fact that, in comparison, the output of the loop filter 3 exhibits a sluggish response and is outputted with a temporal delay is also important and produces a difference in the outputs of the loop filter 3 and second loop filter 18 as per the positions represented by the detection points. A difference in the voltages of the inputted signals is observed by the voltage comparator 19, which outputs this difference. Otherwise, the voltage comparator 19 is constituted to output this difference when this difference is larger than an initial set value and to output a voltage difference signal that corresponds with the magnitude of this difference.

In addition, the polarity of the output signal of the voltage comparator 19 corresponds with the direction of the fluctuations of the oscillation frequency of the VCO 5. Therefore, the output of the voltage comparator 19 is able to correct the oscillation frequency of the VCO 5 by adjusting the DC offset of the output signal of the gm adjustment device 6 by means of the polarity for correcting the fluctuations of the oscillation frequency of the VCO 5 that induces the voltage comparator 19 to identify the voltage difference and output a voltage difference signal.

### Eleventh Embodiment

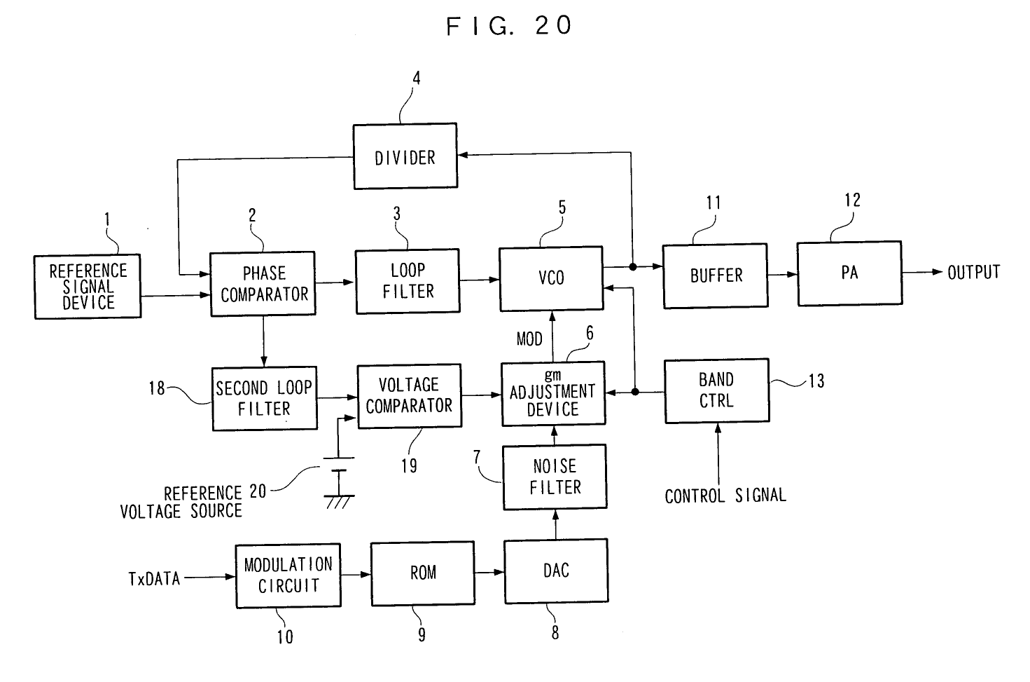

FIG. 20 is a block diagram showing the overall constitution of the modulator according to the eleventh embodiment of the present invention. As shown in FIG. 20, this modulator is constituted by newly providing the block diagram shown in FIG. 18 of the tenth embodiment with a reference voltage source 20 and by inputting the reference voltage of the reference voltage source 20 instead of the output signal of the loop filter 3 inputted to the voltage comparator 19 and by comparing the voltage of the reference voltage source 20 and the output voltage of the second loop filter 18 by means of the voltage comparator 19.

The voltage comparator 19 illustrated in the tenth embodiment compares the output voltage of the loop filter 3 and the output voltage of the second loop filter 18 and corrects the oscillation frequency. However, in the comparison of the outputs of the loop filter 3 and second loop filter 18 as per the tenth embodiment, the difference between the output voltages of the two loop filters that is produced at the time of frequency fluctuations as a result of the time constant difference is utilized, and, therefore, temporally long average value fluctuations are hard to detect and the detection accuracy cannot be increased.

In the eleventh embodiment, the output voltage of the second loop filter 18 with a comparatively low time constant and the reference voltage indicated by the dotted line in FIG. 19 are provided. The degree of stability of the oscillation frequency of the VCO 5 can be raised by increasing the comparison accuracy by comparing the reference voltage of the reference voltage source 20, which is a fixed voltage.

However, the output of the second loop filter 18 varies in accordance with the frequency of the input signal of the reference signal device 1 and as a result of the control of the oscillation frequency of the PLL-controlled VCO 5. Therefore, the voltage of the reference voltage source 20 is used by retaining the output voltage of the second loop filter 18 after the PLL has begun a stable operation or is fixed at a constant DC voltage or used by detecting and retaining the initial difference from the voltage of the second loop filter 18 when the PLL has begun a stable operation.

### Twelfth Embodiment

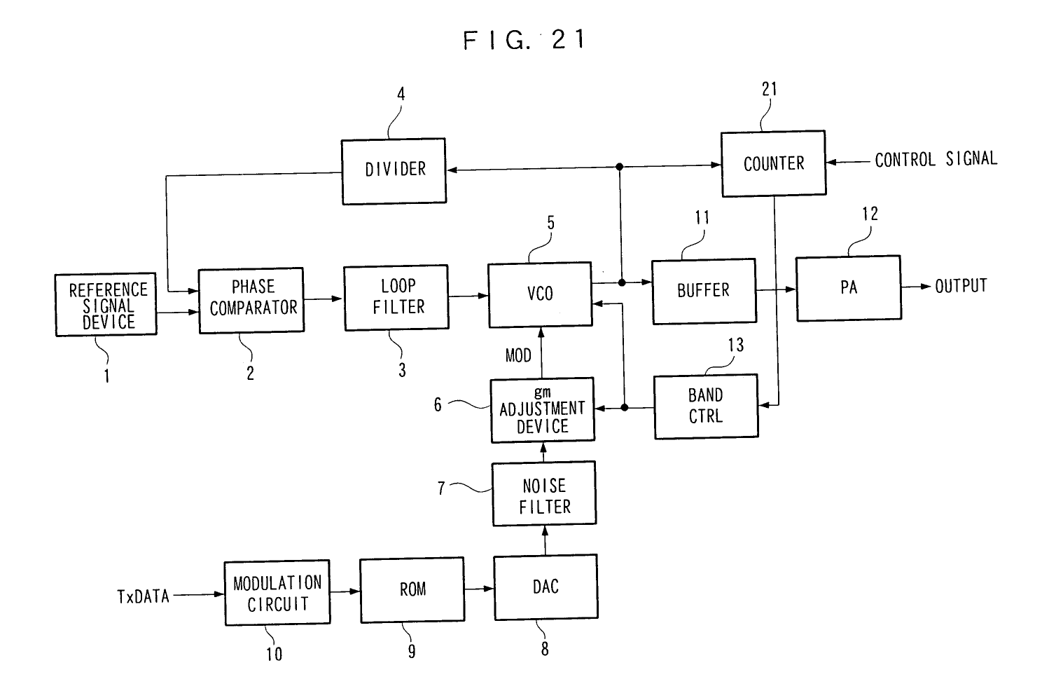

FIG. 21 is a block diagram showing the overall constitution of the modulator of the twelfth embodiment of the present invention. As shown in FIG. 21, this modulator is constituted by newly providing the block diagram shown in FIG. 1 with a counter 21 that judges whether the frequency of the inputted signal is higher or lower than the set target frequency and by also inputting the output signal of the VCO 5 to the counter 21 and inputting the control output of the counter 21 in place of the control signal of the BAND CTRL 13.

As a result of this constitution, the counter 21 judges whether the oscillation frequency of the VCO 5 is higher or lower than the set value and whether oscillation is possible at the target frequency in the selected BAND of the VCO 5 on the basis of the difference from the set value. When BAND switching is required, by making an input to the BAND CTRL 13 as a BAND switching control signal, the PLL is able to track the frequency of the signal inputted by the reference signal device 1 automatically.

### Thirteenth Embodiment

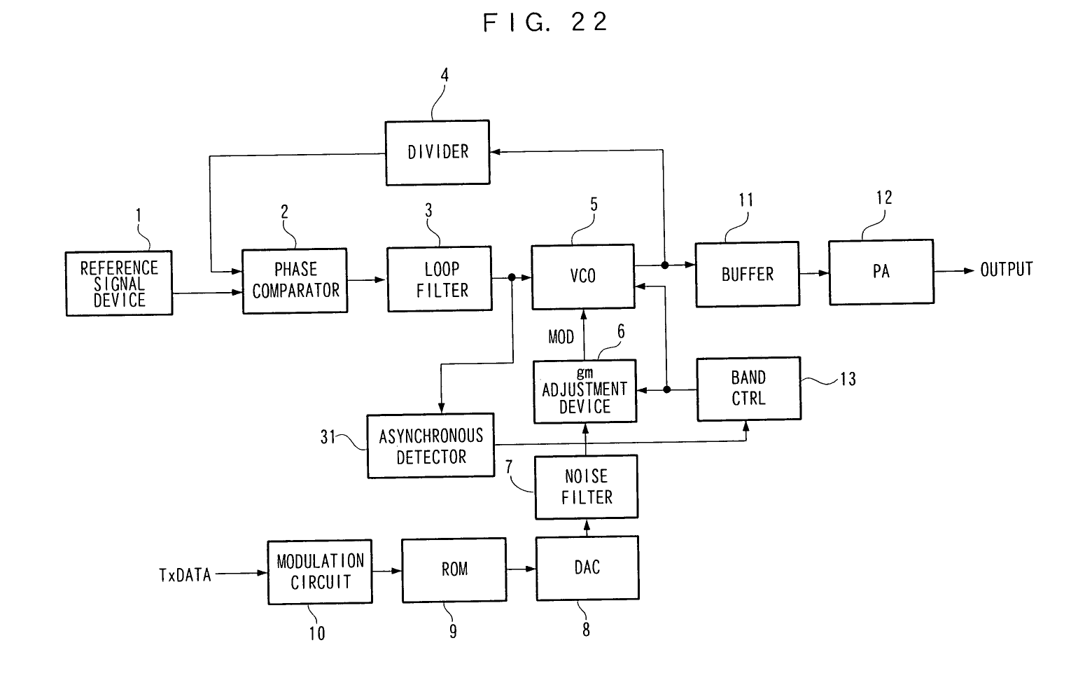

FIG. 22 is a block diagram showing the overall constitution of the modulator according to the thirteenth embodiment of the present invention. As shown in FIG. 22, this modulator is constituted by newly installing an asynchronous detector 31 in the block diagram shown in FIG. 1 and by also inputting the output of the loop filter 3 to the asynchronous detector 31 and inputting the output thereof as the control signal of the BAND CTRL 13.

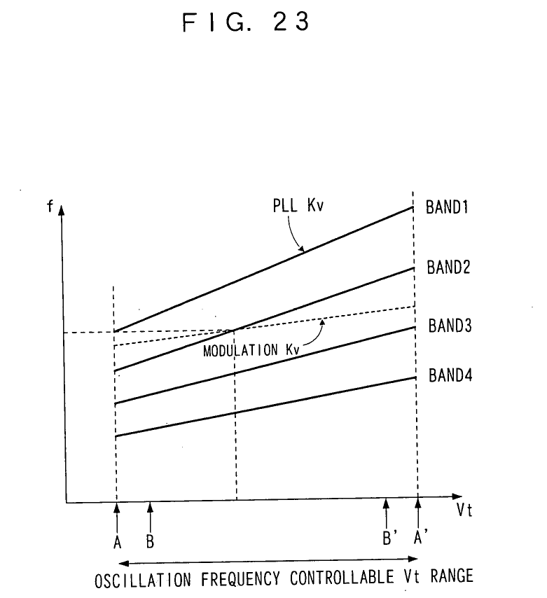

This asynchronous detector 31 observes the output voltage of the PLL loop filter 3 and detects the fact that the output voltage reaches the upper limit or lower limit of the voltage range that permits control of the VCO 5. Otherwise, a certain voltage range is provided and the asynchronous detector 31 detects the fact that the output of the loop filter 3 exceeds the voltage range. Otherwise, a limit is established at which the output voltage of the loop filter 3 can no longer be controlled when the range over which the oscillation frequency of the VCO 5 is controllable is exceeded over a certain period. For example, a reference voltage range (between arrows B and B′ in FIG. 23) for detecting that the oscillation frequency is in the vicinity of arrows A and A′ shown in FIG. 23 or has reached the vicinity of arrows A and A′ or for judging that the limit lies within the operational range (between arrows A and A′ shown in FIG. 23 for the frequency controllable range of the VCO) of the output voltage of the loop filter 3 is established and, if the control voltage Vt goes outside this range, it is judged that that the frequency control limit of the VCO 5 is close. Thus, a state in which lockup by the PLL is possible or impossible is judged.

In the selected oscillation frequency bandwidth of the VCO 5, a state where the target frequency for PLL lockup is outside the bandwidth or a state where phase lockup of the oscillation frequency by the PLL loop is impossible is detected by the asynchronous detector 31 and it is judged whether control of the oscillation frequency of the VCO 5 has reached the upper limit or lower limit. Control can be implemented such that the BAND of the VCO 5 is automatically switched to an oscillation frequency bandwidth that enables control to the target oscillation frequency that permits phase lockup by the PLL.

### Fourteenth Embodiment

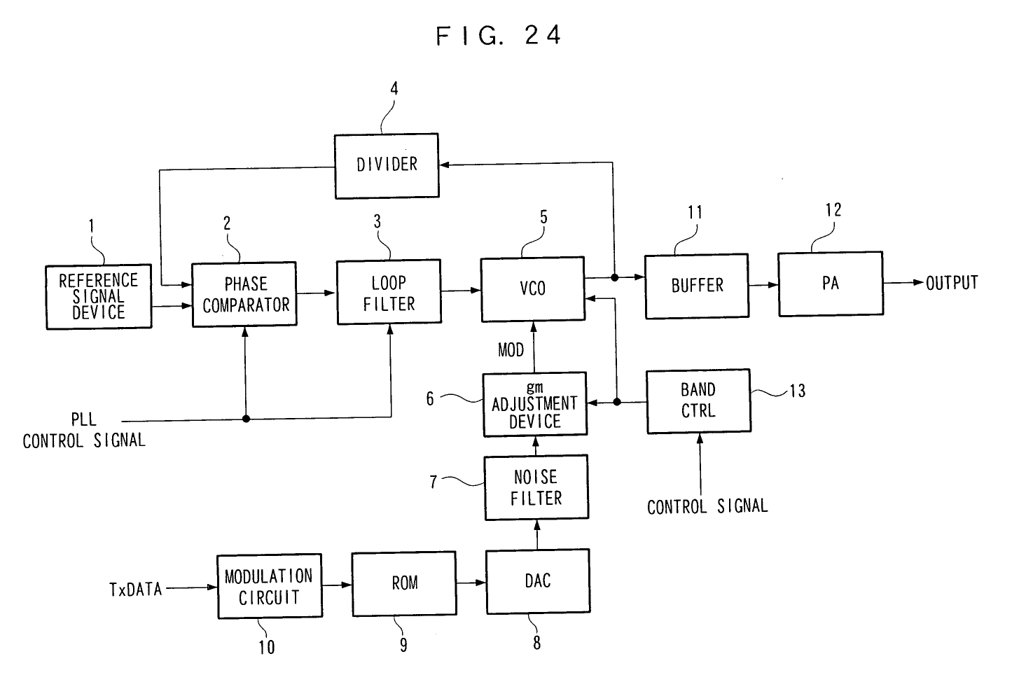

FIG. 24 is a block diagram showing the overall constitution of the modulator according to the fourteenth embodiment of the present invention. As shown in FIG. 24, this modulator is constituted by providing the block diagram shown in FIG. 1 with a function to stop the phase comparator 2 from making the comparison output and establish a high impedance state for this output and a function to hold and output the DC voltage that is immediately outputted to the loop filter 3, irrespective of the input signal and by inputting a PLL control signal input for controlling the operation and stoppage of these functions to the phase comparator 2 and loop filter 3.

The PLL control signal either establishes a high impedance state for the output of the phase comparator 2 or holds the output of the loop filter 3. Otherwise, by establishing a high impedance state for the output of the phase comparator 2 and holding the output of the loop filter 3, the PLL is rendered an open loop during a period in which the VCO 5 is performing a modulation operation, the PLL tracks the fluctuations of the average value of the frequency modulated by the VCO 5 and, hence, the center frequency of the output modulation signal is prevented from shifting from the target value. Further, control can be implemented to render the PLL a closed loop by means of the PLL control signal in a modulation-free period to reset the oscillation frequency of the VCO 5 to the target value and PLL closed/open loop control can be implemented in sync with modulation data to render the PLL an open loop in a transmission-data modulation period and render the PLL a closed loop in a modulation-free period, whereby the modulation accuracy can be improved. Further, when a closed loop is implemented, the output of the phase comparator 2 can be stopped and afforded a high impedance state or the output of the loop filter 3 can be held. Alternatively, both such measures can be implemented.

### Fifteenth Embodiment

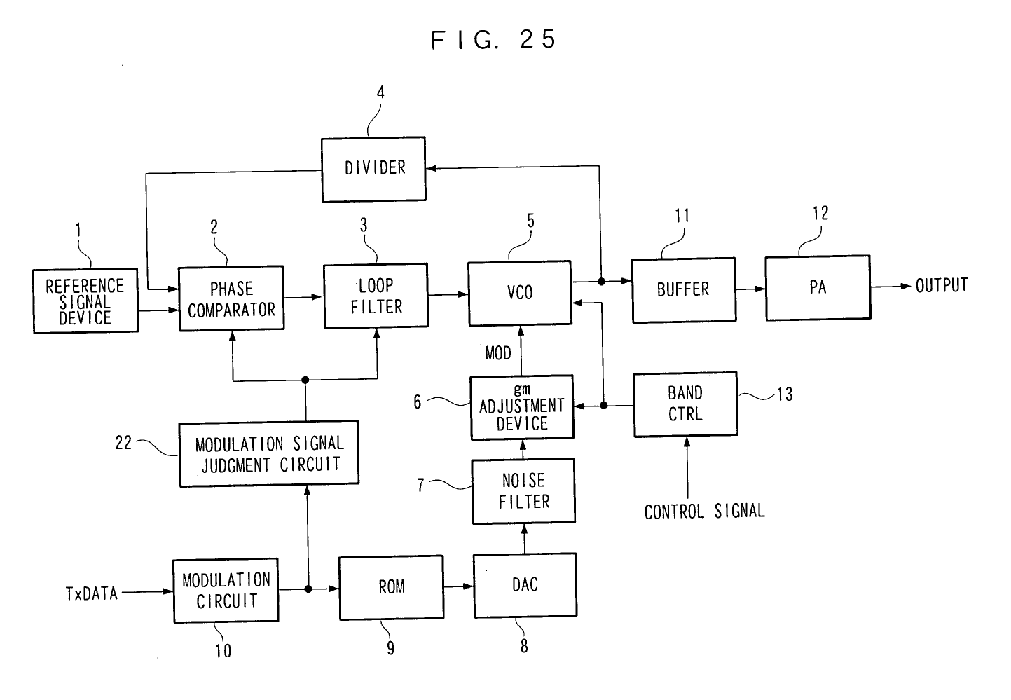

FIG. 25 is a block diagram showing the overall constitution of the modulator according to the fifteenth embodiment of the present invention. As shown in FIG. 25, this modulator is constituted by newly providing the block diagram shown in FIG. 24 of the fourteenth embodiment with a modulation signal judgment circuit 22 that observes information in the inputted transmission data and judges the order of simple bits without transmission information or the order of data bits for which transmission information exists.

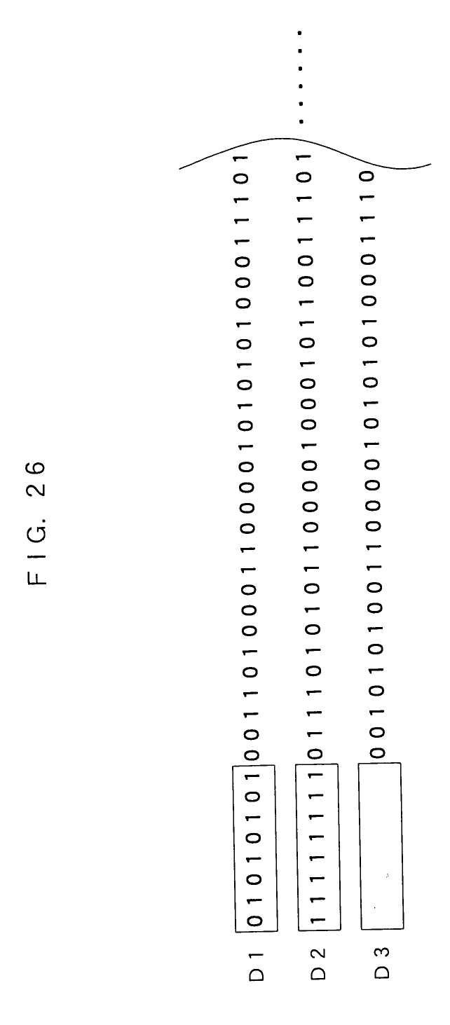

The output signal of the modulation circuit 10 is inputted to the modulation signal judgment circuit 22 at the same time as to the ROM 9. The inputted signal is observed by the modulation signal judgment circuit 22 and, as per the examples of bit data strings shown in FIG. 26, in cases where there is no data in an initial data period as in the case of the data in the square frames in FIG. 26 of the bit strings (see D1 to D3 in FIG. 26) and there exists a period in which regular bits such as front-end data indicating that data bits are to follow subsequently are lined up, these conditions are detected. In addition, depending on the case, cases where a period representing the data end exists are likewise detected and it is judged whether this period is a period with or without transmission-data transmission information, whereupon a signal corresponding with this judgment is outputted. By using the output of the modulation signal judgment circuit 22 as the PLL control signal of the fourteenth embodiment, the PLL loop can be automatically opened and closed.

### Sixteenth Embodiment

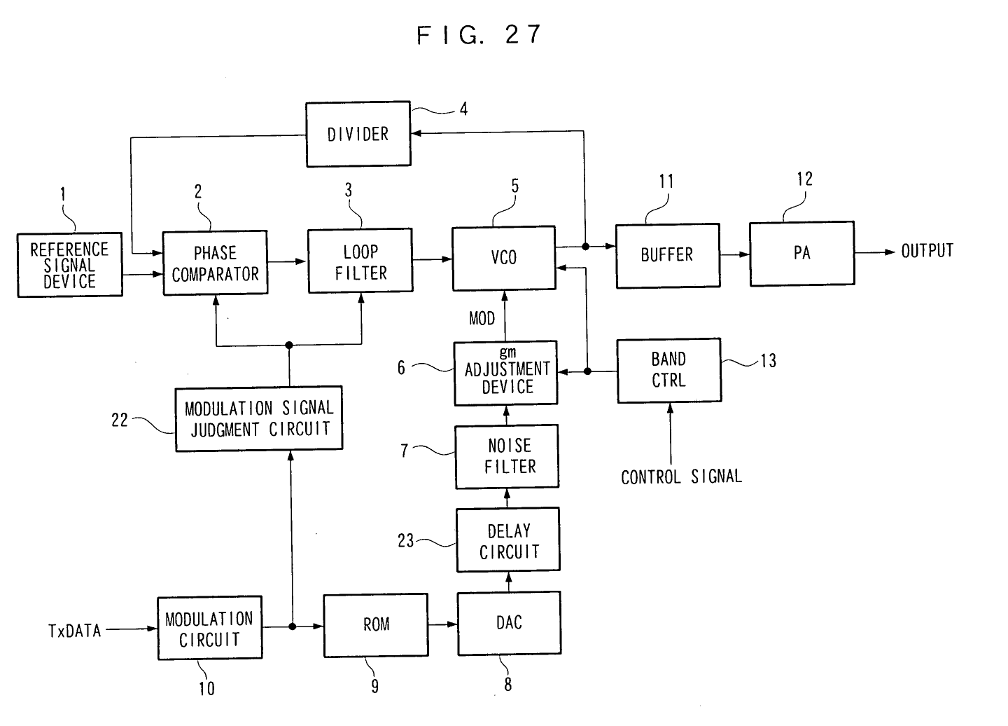

FIG. 27 is a block diagram showing the overall constitution of the modulator according to the sixteenth embodiment of the present invention. As shown in FIG. 27, the block diagram shown in FIG. 26 in the fifteenth embodiment has a delay circuit 23 newly inserted between the DAC 8 and noise filter 7 such that, each time automatic closing/opening of the PLL loop is performed by means of the modulation signal judgment circuit 22, the transmission data (TxDATA) signal is prevented from being transmitted to the VCO 5 prior to completion of switching to an open PLL loop via the modulation circuit 10.

As a result, the modulator is constituted such that the oscillation frequency of the VCO 5, which is interleaved when the PLL is in the closed loop state, is inputted to the VCO 5 before the modulation signal causes the PLL loop to make the transition to the open loop state and does not change. Further, by inserting the delay circuit 23 before and after the modulation signal judgment circuit 22 when the PLL loop open/close operation by the modulation signal judgment circuit 22 is faster than the time it takes for the transmission data to arrive at the VCO 5, the temporal positional relationship of the time taken for the transmission data to arrive at the VCO 5 and the PLL loop open/close operation is afforded a suitable position, whereby the oscillation frequency of the VCO 5 can be stabilized.

### Seventeenth Embodiment

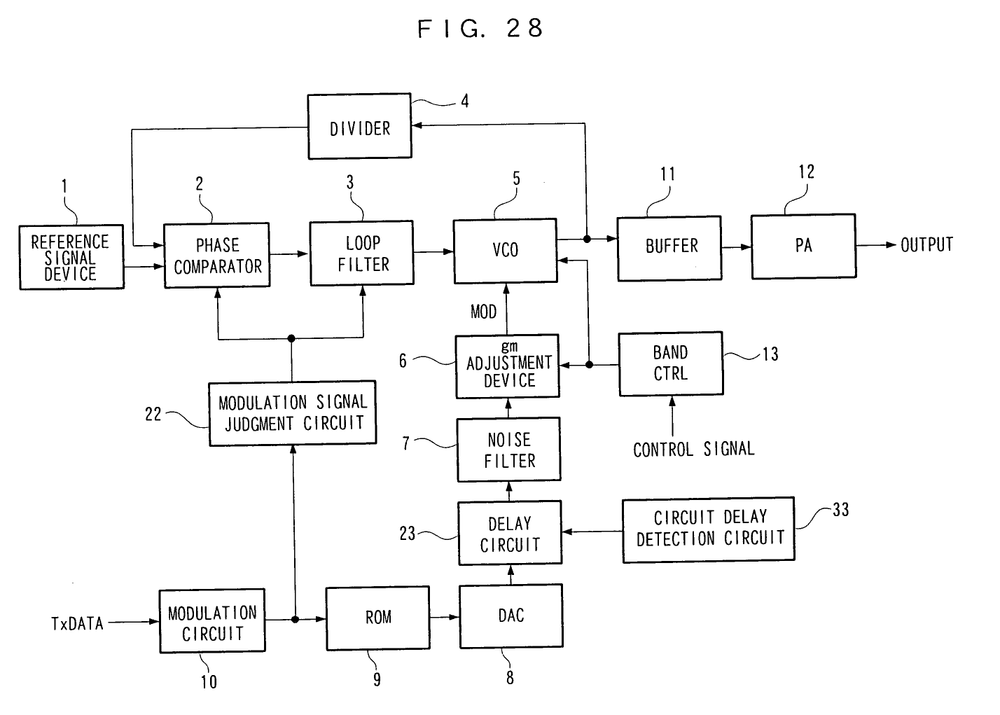

FIG. 28 is a block diagram showing the overall constitution of the modulator according to the seventeenth embodiment of the present invention. As shown in FIG. 28, the modulator is constituted by newly providing the block diagram shown in FIG. 27 of the sixteenth embodiment with a circuit delay detection circuit 33, wherein the circuit delay detection circuit 33 has an oscillator, such as a multi-vibrator, mounted therein, that detects the delay with respect to the circuit signal from the phase delay of the output via the reference signal to the reference filter, for example, wherein the circuit delay detection circuit 33 detects a delay that is the same as the circuit delay of the modulation circuit 10, the ROM 9, the DAC 8, the noise filter 7, the gm adjustment device 6, and the delay circuit 23 by detecting the effect which the circuit elements have on the delay from an increase or decrease in the frequency of the oscillator and so forth.

As a result of this constitution, the delay amount is outputted as a detection signal and, in order to permit a variation in the delay amount of the delay circuit 23, same is provided with a control terminal for varying the delay amount, wherein the output signal of the circuit delay detection circuit 33 is inputted to the control terminal of the delay circuit 23, and the delay amount of the delay circuit 23 is controlled to absorb fluctuations caused by the source voltage, circuit current, temperature, and so forth for the total of the circuit delays of the modulation circuit 10, ROM 9, DAC 8, noise filter 7, gm adjustment device 6, and the delay circuit 23 and to keep the time until the transmission data inputted by the modulation circuit 10 is inputted to the VCO 5 constant.

In addition, by detecting the circuit delay corresponding with fluctuations of the operating speed of the loop open/close control performed by the modulation signal judgment circuit 22 in the circuit delay detection circuit 33 in a case where the delay circuit 23 is used before and after the signal-system side modulation signal judgment circuit 22 that performs PLL loop open/close control, it is possible to ensure that the temporal positional relationship between the arrival of transmission data at the VCO 5 and the PLL loop open/close operation by the modulation signal judgment circuit 22 does not fluctuate as a result of variations in the circuit characteristics.

### Eighteenth Embodiment

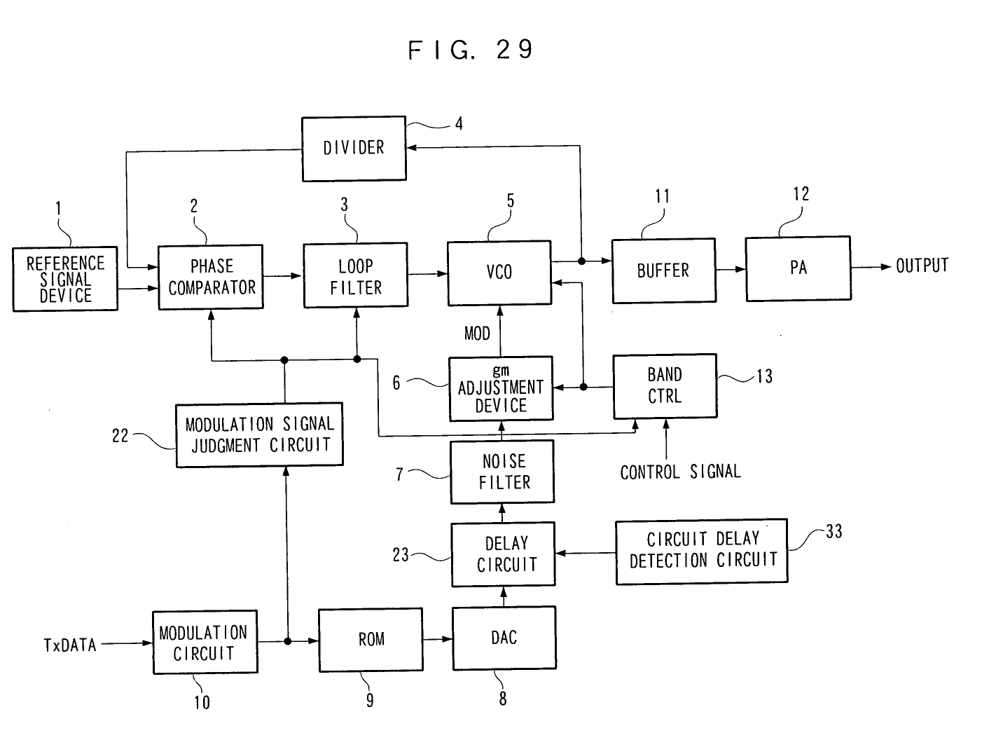

FIG. 29 is a block diagram showing the overall constitution of the modulator according to the eighteenth embodiment of the present invention. As shown in FIG. 29, this modulator is constituted such that, in the block diagram shown in FIG. 28 of the seventeenth embodiment, the PLL control signal outputted by the modulation signal judgment circuit 22 is also inputted to the BAND CTRL 13 and switching of the BAND of the VCO 5 by the BAND CTRL 13 in sync with the period in which the modulation signal judgment circuit 22 controls the PLL to a closed loop state and adjustment of the transmission conductance of the gm adjustment device 6 are performed.

As a result of this constitution, control is implemented to prevent fluctuations of the frequency of the output signal during the modulation period or to perform only switching of the BAND of the VCO 5 by the BAND CTRL 13 in sync during the period in which the PLL is controlled to the closed loop state. Otherwise, the switching of the BAND of the VCO 5 by the BAND CTRL 13 and abrupt changes in the transmission conductance of the gm adjustment device 6 are restricted during the period in which the PLL is controlled to the open loop state and the rate of variation in the transmission conductance is restricted to the rate of absorption of the frequency fluctuations that accompany the variation in the transmission conductance of the output modulation signal within the range permitted by the communication system, whereby the PLL lockup operation can be executed in a state where the frequency stability of the output modulation signal is secured.

### Nineteenth Embodiment

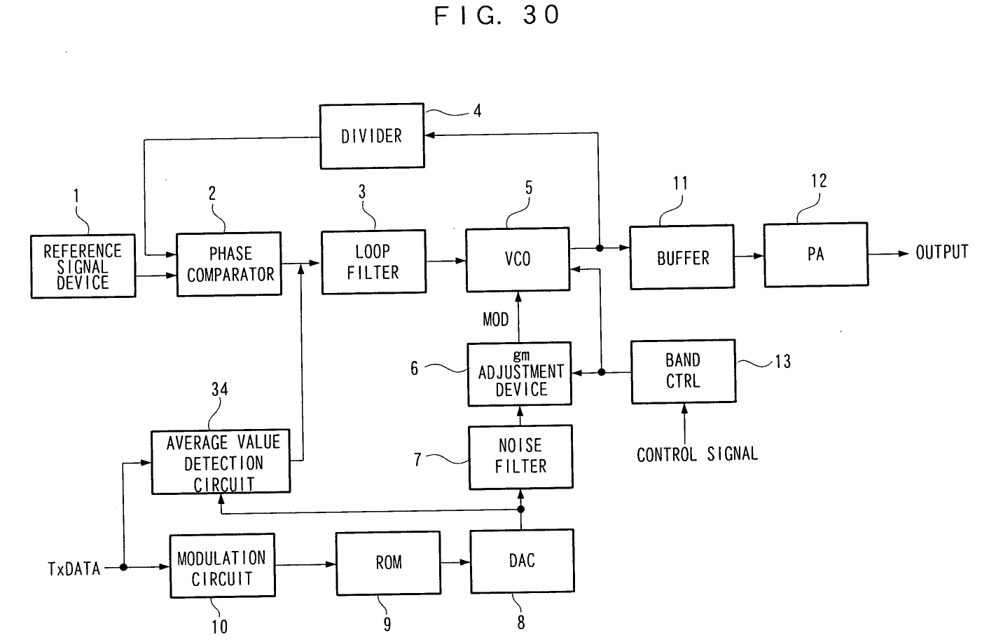

FIG. 30 is a block diagram showing the overall constitution of the modulator of the nineteenth embodiment of the present invention. As shown in FIG. 30, the modulator is constituted by newly providing the block diagram shown in FIG. 1 with an average value detection circuit 34 that detects fluctuations of the average value of the transmission data, wherein the output of the DAC 8 is inputted to the input of the average value detection circuit 34 and the output of the average value detection circuit 34 is inputted to the loop filter 3 together with the output of the phase comparator 2.

As described in the first embodiment, the time constant of the loop filter 3 is set large so that the PLL tracks variations in the frequency of the output modulation signal and the center value of the oscillation frequency of the VCO 5 does not fluctuate. However, because the transmission data is regulation-free, the problem of tracking the fluctuations of the average value of the output modulation signal for a relatively long time and, as a result, the center value of the oscillation frequency of the VCO 5 shifting from the target value still remains. This problem is solved by the nineteenth embodiment through advance detection of fluctuations of the average value of the transmission data signal by the average value detection circuit 34. Fluctuations of the frequency of the output modulation signal can be prevented by inputting beforehand the detection signal to the loop filter 3 with an amplitude and polarity that counteract the fluctuations of the oscillation frequency of the VCO 5 in accordance with the fluctuations of the average value of the transmission signal.

Further, although modulators of the present invention were described as single pieces in the first to nineteenth embodiments, these embodiments may be combined in a combined application and are not limited to such a stand-alone constitution.

Moreover, the constitution may be a semiconductor integrated circuit, wherein a modulator rendered by using the modulators described in the first to nineteenth embodiments independently or in combination is partially used, a wired and wireless communication device that is partially constituted by the modulator, and a wired and wireless communication device, wherein the semiconductor integrated circuit is installed and formed, whereby a modulation system with an extremely stable, high-performance modulation performance can be implemented with a very small circuit scale and power consumption. In addition, the respective modulators of the first to nineteenth embodiments can be implemented by means of digital signal processing technology to obtain semiconductor integrated circuits and wired and wireless communication devices in the same way.

Industrial Applicability

The present invention makes is possible to implement a modulation system with an extremely stable, high-performance modulation performance that has a built-in VCO in accordance with VCO direct modulation technology and stabilization technology for the modulation performance of the VCO which further comprises a frequency modulation function, and is useful for usage in modulators, semiconductor integrated circuits and wired and wireless communication devices, and so forth, that constitute a modulation system by installing an oscillation circuit in an IC.

1. A modulator, comprising:
a reference signal device for outputting a reference signal;
a phase comparator;
a loop filter;
a divider;
a voltage controlled oscillator comprising a first input terminal for controlling an oscillation frequency, a second input terminal for controlling the frequency directly independently of the first input terminal, and a third input terminal for controlling the oscillation frequency bandwidth;
a conductance adjustment device;
a noise filter;
a digital/analog converter;
a read-only memory;
a modulation circuit for generating a select control signal based on an inputted transmission data signal;
a band controller for controlling the oscillation frequency bandwidth; and
a power amplifier for amplifying and outputting an input via a buffer of a output modulation signal from a VCO, wherein
the reference signal and the output signal of the VCO that has passed via the divider are inputted to the phase comparator, and a phase-locked loop is constituted by the phase comparator, the loop filter, the VCO, and the divider, wherein
the oscillation frequency of the VCO is modulated by converting a transmission data signal into an IQ modulation signal with a predetermined modulation bandwidth that is phase-modulated by the select control signal inputted to the ROM via the modulation circuit, converting the IQ modulation signal into an analog signal by means of the DAC, and inputting the analog signal to the gm adjustment device via the noise filter before converting the analog signal to an appropriate signal level that corresponds with the control sensitivity of the VCO and inputting the converted analog signal to a second input terminal for controlling the direct frequency of the VCO, and
switching of the oscillation bandwidth of the VCO is controlled by inputting a control signal that is outputted by the band controller to the third input terminal of the VCO and the control terminal of the gm adjustment device at the same time as controlling the transmission conductance of the gm adjustment device in order to establish the modulation depth of the input signal from the second input terminal of the VCO that corresponds with the VCO control sensitivity, which varies for each BAND, at a target modulation depth.

2. The modulator according to claim 1, wherein
the gm adjustment device comprises a first input terminal for inputting thereto a BAND switching control signal by the band controller and a second input terminal for inputting thereto the output of the loop filter,
the output of the loop filter is inputted to the second input terminal, and
after the BAND is set, the transmission conductance of the gm adjustment device is controlled in accordance with the frequency controlled by the PLL.

3. The modulator according to claim 1, wherein
the modulator further comprises a DAC control circuit for outputting an offset adjustment signal for the DA-converted output,
the DAC comprises a first input terminal for inputting an IQ modulation signal from the ROM and a second input terminal for inputting the DA-converted output offset adjustment signal to be outputted,
the output of the DAC CTRL is connected to the second input terminal of the DAC, and
a shift in the center frequency of the modulation frequency produced in the process from the output of the DAC to the VCO is corrected by means of the DAC CTRL.

4. The modulator according to claim 1, wherein
the output stage of the buffer comprises:
a counter for detecting any of an upper limit, lower limit or modulation bandwidth of the modulation frequency; and
a data comparison circuit for comparing an upper limit frequency rated value, lower limit frequency rated value, or a rated value for the modulation frequency bandwidth of the modulation signal with information on a detected upper limit frequency, a detected lower limit frequency or a detected modulation frequency bandwidth of the input from the counter, wherein
the output of the buffer is inputted to the counter, the output of the counter is inputted to the data comparison circuit, respective items of information on the frequency of the modulation signal are compared and analyzed by the data comparison circuit, favorability of the modulation is judged, the judgment result is inputted to the gm adjustment device as a control signal, and the modulation depth is controlled so that the upper limit frequency, lower limit frequency or modulation frequency bandwidth of the modulation signal has the correct value.

5. The modulator according to claim 4, wherein the output of the data comparison circuit is inputted to the band controller and, even when it is impossible to control the modulation depth so that the upper limit frequency, lower limit frequency or modulation bandwidth of the modulation signal has the correct value by means of the gm adjustment device alone, the modulation depth and BAND are controlled simultaneously by controlling the frequency BAND of the VCO by means of the band controller.

6. The modulator according to claim 1, wherein
the gm adjustment device comprises a first input terminal for inputting thereto a signal from the noise filter, a second input terminal for inputting thereto a signal from the band controller, and a third input terminal for allowing the transmission conductance to be varied separately from the first and second input terminals,
a temperature detector is provided for detecting the temperature of the environment and outputting a temperature variation as a signal,
the output of the temperature detector is connected to the third input terminal, and
the output of the temperature detector for temperature fluctuations is inputted to the gm adjustment device and the transmission conductance is varied to counteract the temperature fluctuations of the modulation depth, the temperature fluctuations being caused to arise in the modulation depth of the modulation signal as a result of temperature fluctuations of the oscillation frequency of the VCO, temperature fluctuations of the transmission conductance, and temperature fluctuations of the amplitude of the signal.

7. The modulator according to claim 1, further comprising a frequency sensing circuit for inputting thereto two signals, one being an output of the divider and an output from the reference signal device, comparing the frequencies of the two input signals, and outputting the result, and a second loop filter for inputting thereto the output of the frequency sensing circuit is, wherein
a shift between a center frequency that is judged from the upper and lower limits of the oscillation frequency of the VCO and the frequency of a signal from the reference signal device is detected, and
the output of the frequency sensing circuit is inputted to the gm adjustment device via the second loop filter and added together with a fixed offset to the output signal of the gm adjustment device.

8. The modulator according to claim 7, wherein the output of the second loop filter is combined with the output of the loop filter and inputted as a VCO control signal.

9. The modulator according to claim 7, wherein the output of the frequency sensing circuit is combined with the output of the phase comparator and inputted as a VCO control signal via a loop filter.

10. The modulator according to claim 1, further comprising a second loop filter and a voltage comparator, wherein the phase comparator is newly provided with a second output terminal, the output of the second output terminal is inputted to the second loop filter, the output of the loop filter and the output of the second loop filter are each inputted to the voltage comparator, and the output of the voltage comparator is inputted to the gm adjustment device.

11. The modulator according to claim 10, wherein the voltage comparator comprises a reference voltage source for outputting a reference voltage instead of the inputted loop filter output, the output of the second loop filter and the reference voltage are inputted to the voltage comparator, and the output of the voltage comparator is inputted to the gm adjustment device.

12. The modulator according to claim 1, further comprising a counter for inputting thereto the output of the VCO and a control signal for setting the final oscillation frequency of the VCO, wherein
the upper and lower limits for judging the count amount of the counter are set in accordance with the control signal thus inputted to the counter, and
the BAND of the VCO is switch-controlled based on the counter-amount judgment result.

13. The modulator according to claim 1, further comprising an asynchronous detector for observing the output voltage of the loop filter and judging a state in which PLL phase lock-up is impossible, wherein the output of the loop filter is also inputted to the asynchronous detector and the output of the asynchronous detector is inputted as a control signal for the band controller.

14. The modulator according to claim 1, wherein the phase comparator comprises a function to stop the comparison output and afford the output a high impedance state, and the loop filter comprises a function to hold and output an immediate-output DC voltage regardless of the input signal, wherein a PLL control signal is inputted for controlling the operation and stoppage of the respective functions of the phase comparator and loop filter.

15. The modulator according to claim 14, further comprising a modulation signal judgment circuit for outputting the PLL control signal inputted to the phase comparator and the loop filter, wherein the output signal of the modulation circuit is inputted to the modulation signal judgment circuit, the output of the modulation signal judgment circuit is inputted to the phase comparator and the loop filter, and the output signal of the modulation circuit is judged to be a modulation-free signal or a modulated signal.

16. The modulator according to claim 15, wherein a delay circuit is installed between the DAC and noise filter, thereby preventing the output signal of the modulation circuit from being transmitted to the VCO prior to completion of switching of the PLL loop to an open loop, when it is judged by the modulation signal judgment circuit that the output signal of the modulation circuit has been switched from a modulation-free signal to a modulated signal and the PLL loop is switched from a closed loop to an open loop.

17. The modulator according to claim 16, further comprising a circuit delay detection circuit for detecting an operation delay or a transmission delay of a circuit, the delay circuit comprising a control terminal for controlling a delay amount to allow the delay amount to be controlled, wherein the circuit delay detection circuit produces a delay equal to that of the delay circuit, noise filter and gm adjustment device, detects fluctuations in the circuit delay, outputs the fluctuations as an output signal and inputs the output signal to the control terminal of the delay circuit, and sets the delay amount of the delay circuit at a minimum delay amount.

18. The modulator according to claim 16, wherein the output signal of the modulation signal judgment circuit is also inputted to a band controller, and when the oscillation frequency bandwidth of the VCO or the transmission conductance of the gm adjustment device is varied under the control of the band controller, the BAND of the VCO is switched in sync with a modulation-data modulation-free period or the conductance of the gm adjustment device is varied by means of a control signal inputted by the modulation signal judgment circuit.

19. The modulator according to claim 16, further comprising an average value detection circuit for inputting thereto the DAC output signal and a transmission data signal and detecting the frequency average of the transmission data signal, wherein the output of the average value detection circuit is converted to a suitable control signal including average value information, and inputted to the loop filter together with the output signal of the phase comparator.

20. A modulator rendered by using the modulators of claims 1 to 19 in a combined application.

21. A semiconductor integrated circuit comprising, as a part thereof, a modulator rendered by using a modulator according to any one of claims 1 to 19 in a single or combined application.

22. A wired and wireless communication device comprising, as a part thereof, a modulator rendered by using a modulator according to any one of claims 1 to 19 in a single or combined application.

23. A wired and wireless communication device comprising the semiconductor integrated circuit according to claim 20 is installed.

24. A semiconductor integrated circuit comprising, as apart thereof, a modulator rendered by using a modulator according to any one of claims 1 to 19 in a single or combined application and implemented by means of digital signal processing technology.

25. A wired and wireless communication device comprising, as a part thereof, a semiconductor integrated circuit comprising as part thereof a modulator rendered by using a modulator according to any one of claims 1 to 19 in a single or combined application and implemented by means of digital signal processing technology.
